(19) United States
(12) Patent Application Publication
(10) Pub. No.: US 2015/0064092 A1
(43) Pub. Date: Mar. 5, 2015

(54) METHODS AND REACTORS FOR PRODUCING SOLID CARBON NANOTUBES, SOLID CARBON CLUSTERS, AND FORESTS

(71) Applicant: Seerstone LLC, Provo, UT (US)

(72) Inventor: Dallas B. Noyes, Provo, UT (US)

(73) Assignee: SEERSTONE LLC, Provo, UT (US)

(21) Appl. No.: 14/388,757

(22) PCT Filed: Mar. 15, 2013
(86) PCT No.: PCT/US2013/000073

§ 371 Date: Sep. 26, 2014

Related U.S. Application Data
(60) Provisional application No. 61/624,753, filed on Apr. 16, 2012.

(51) Int. Cl. C01B 31/02; B01J 15/00; B82Y 40/00

(52) U.S. Cl. CPC C01B 31/0226; B82Y 40/00; B01J 15/005; C01B 2202/00
USPC 423/304; 204/192.34; 423/447.3; 423/416; 423/415.1; 585/16; 568/403; 585/24; 585/20; 564/469; 568/902; 422/619

(57) ABSTRACT

Methods of producing fibrous solid carbon forests include reacting carbon oxides with gaseous reducing agents in the presence of a catalyst having a predetermined grain size to cause growth of fibrous solid carbon forests upon a surface of the metal. The fibrous solid carbon forests are substantially perpendicular to the surface of the metal thus creating the “forests”. A bi-modal forest composition of matter is described in which a primary distribution of fibrous solid carbon comprises the forest and a secondary distribution of fibrous solid carbon is entangled with the primary distribution. A reactor includes a catalyst, a means for facilitating the reduction of a carbon oxide to form solid carbon forests on a surface of the catalyst, and a means for removing the solid carbon forest from the surface of the metal catalyst.

### PRIORITY CLAIM

This application claims the benefit of the filing date of U.S. Provisional Patent Application Ser. No. 61/624,753, filed Apr. 16, 2012, for “Methods and Reactors for Producing Solid Carbon Clusters and Forests,” the disclosure of which is hereby incorporated herein in its entirety by this reference.

### TECHNICAL FIELD

Embodiments of the disclosure relate to the large-scale catalytic conversion of a carbon-containing feedstock into solid carbon, and, more specifically, to methods of converting mixtures of carbon monoxide, carbon dioxide, or any combination thereof to create carbon nanotube structures.

### BACKGROUND

U.S. Patent Publication No. 2012/0034150 A1, published Feb. 9, 2012, the disclosure of which is hereby incorporated herein in its entirety by this reference, discloses background information hereto.

Additional information is disclosed in the following documents, the disclosure of each of which is hereby incorporated herein in its entirety by this reference:
1. International Application No. ______ (attorney docket No. 3525-P10945.1PC), filed on even date herewith, for “Methods and Structures for Reducing Carbon Oxides with Non-Ferrous Catalysts,” which claims the benefit of U.S. Ser. No. 61/624,702, filed Apr. 16, 2012, in the name of Dallas B. Noyes;
2. International Application No. ______ (attorney docket No. 3525-P10946.1PC), filed on even date herewith, for “Methods and Systems for Thermal Energy Recovery from Production of Solid Carbon Materials by Reducing Carbon Oxides,” which claims the benefit of U.S. Ser. No. 61/624,573, filed Apr. 16, 2012, in the name of Dallas B. Noyes;
3. International Application No. ______ (attorney docket No. 3525-P10947.1PC), filed on even date herewith, for “Methods for Producing Solid Carbon by Reducing Carbon Dioxide,” which claims the benefit of U.S. Ser. No. 61/624,723, filed Apr. 16, 2012, in the name of Dallas B. Noyes;
4. International Application No. ______ (attorney docket No. 3525-P11002.1PC), filed on even date herewith, for “Methods for Treating an Offgas Containing Carbon Oxides,” which claims the benefit of U.S. Ser. No. 61/624,513, filed Apr. 16, 2012, in the name of Dallas B. Noyes;
5. International Application No. ______ (attorney docket No. 3525-P11248.1PC), filed on even date herewith, for “Methods for Using Metal Catalysts in Carbon Oxide Catalytic Converters,” which claims the benefit of U.S. Ser. No. 61/624,848, filed Apr. 16, 2012, in the name of Dallas B. Noyes;
6. International Application No. ______ (attorney docket No. 3525-P11249.1PC), filed on even date herewith, for “Methods and Systems for Capturing and Sequestering Carbon and for Reducing the Mass of Carbon Oxides in a Waste Gas Stream,” which claims the benefit of U.S. Ser. No. 61/624,462, filed Apr. 16, 2012, in the name of Dallas B. Noyes;
7. International Application No. ______ (attorney docket No. 3525-P11361.1PC), filed on even date herewith, for “Methods and Systems for Forming Ammonia and Solid Carbon Products,” which claims the benefit of U.S. Ser. No. 61/671,464, filed Jul. 13, 2012, in the name of Dallas B. Noyes; and
8. International Application No. ______ (attorney docket No. 3525-P11771PC), filed on even date herewith, for “Carbon Nanotubes Having a Bimodal Size Distribution,” which claims the benefit of U.S. Ser. No. 61/637,229, filed Apr. 23, 2012, in the name of Dallas B. Noyes.

Solid carbon has numerous commercial applications. These applications include longstanding uses such as uses of carbon black and carbon fibers as a filler material in tires, inks, etc., many uses for various forms of graphite (e.g., pyrolytic graphite in heat shields) and innovative and emerging applications for buckminsterfullerene and carbon nanotubes. Conventional methods for the manufacture of various forms of solid carbon typically involve the pyrolysis of hydrocarbons in the presence of a suitable catalyst. Hydrocarbons are typically used as the carbon source due to historically abundant availability and relatively low cost. The use of carbon oxides as the carbon source in the production of solid carbon has largely been unexploited.

Carbon oxides, particularly carbon dioxide, are abundant gases that may be extracted from point-source emissions such as the exhaust gases of hydrocarbon combustion or from some process off-gases. Carbon dioxide may also be extracted from the air. Because point-source emissions have much higher concentrations of carbon dioxide than does air, they are often economical sources from which to harvest carbon dioxide. However, the immediate availability of air may provide cost offsets by eliminating transportation costs through local manufacturing of solid carbon products from carbon dioxide in air.

Carbon dioxide is increasingly available and inexpensive as a byproduct of power generation and chemical processes in which an object is to reduce or eliminate the emission of carbon dioxide into the atmosphere by capture and subsequent sequestration of the carbon dioxide (e.g., by injection into a geological formation). For example, the capture and sequestration of carbon dioxide is the basis for some “green” coal-fired power stations. In current practice, capture and sequestration of the carbon dioxide entails significant cost.

There is a spectrum of reactions involving carbon, oxygen, and hydrogen wherein various equilibria have been identified. Hydrocarbon pyrolysis involves equilibria between hydrogen and carbon that favors solid carbon production, typically with little or no oxygen present. The Boudouard reaction, also called the “carbon monoxide disproportionation reaction,” is the range of equilibria between carbon and oxygen that favors solid carbon production, typically with little or no hydrogen present. The Bosch reaction is within a region of equilibria where all of carbon, oxygen, and hydrogen are present under reaction conditions that also favor solid carbon production.

The relationship between the hydrocarbon pyrolysis, Boudouard, and Bosch reactions may be understood in terms of a C—H—O equilibrium diagram, as shown in FIG. 1. The C—H—O equilibrium diagram of FIG. 1 shows various known routes to solid carbon, including carbon nanotubes (“CNTs”). The hydrocarbon pyrolysis reactions occur on the equilibrium line that connects H and C and in the region near the left edge of the triangle to the upper left of the dashed lines. Two dashed lines are shown because the transition between the pyrolysis zone and the Bosch reaction zone appears to change with reactor temperature. The Boudouard, or carbon monoxide disproportionation reactions, occur near the equilibrium line that connects O and C (i.e., the right edge of the triangle). The equilibrium lines for various temperatures that traverse the diagram show the approximate regions in which solid carbon will form. For each temperature, solid carbon generally forms in the regions above the associated equilibrium line, but will not generally form in the regions below the equilibrium line. The Boudouard reaction zone appears at the right side of the triangle. In this zone, the Boudouard reaction is thermodynamically preferred over the Bosch reaction. In the region between the pyrolysis zone and the Boudouard reaction zone and above a particular reaction temperature curve, the Bosch reaction is thermodynamically preferred over the Boudouard reaction.

CNTs are valuable because of their unique material properties, including strength, current-carrying capacity, and thermal and electrical conductivity. Current bulk use of CNTs includes use as an additive to resins in the manufacture of composites. Research and development on the applications of CNTs is very active with a wide variety of applications in use or under consideration. One obstacle to widespread use of CNTs has been the cost of manufacture.

U.S. Pat. No. 7,794,690 (Abatzoglou et al.) teaches a dry reforming process for sequestration of carbon from an organic material. Abatzoglou discloses a process utilizing a 2D carbon sequestration catalyst with, optionally, a 3D dry reforming catalyst. For example, Abatzoglou discloses a two-stage process for dry reformation of an organic material (e.g., methane, ethanol) and CO₂ over a 3D catalyst to form syngas, in a first stage, followed by carbon sequestration of syngas over a 2D carbon steel catalyst to form CNTs and carbon nanofilaments. The 2D catalyst may be an active metal (e.g., Ni, Rh, Ru, Cu—Ni, Sn—Ni) on a nonporous metallic or ceramic support, or an iron-based catalyst (e.g., steel), on a monolith support. The 3D catalyst may be of similar composition, or may be a composite catalyst (e.g., Ni/ZrO₂—Al₂O₃) over a similar support. Abatzoglou teaches preactivation of a 2D catalyst by passing an inert gas stream over a surface of the catalyst at a temperature beyond its eutectic point, to transform the iron into its alpha phase. Abatzoglou teaches minimizing water in the two-stage process or introducing water in low concentrations (0 to 10 wt %) in a reactant gas mixture during the dry reformation first stage.

### DISCLOSURE

This disclosure relates generally to catalytic conversion processes for reducing carbon oxides to a valuable solid carbon product, and, in particular, to the use of carbon oxides (e.g., carbon monoxide (CO) and/or carbon dioxide (CO₂)) as the primary carbon source for the production of solid carbon products (e.g., buckminsterfullerenes) utilizing a reducing agent (e.g., hydrogen or a hydrocarbon) in the presence of a catalyst. The methods may be used to manufacture solid carbon products in various morphologies and to catalytically convert carbon oxides into solid carbon and water. One of the morphologies that may be formed is single-wall carbon nanotubes.

In some embodiments, a method of producing fibrous solid carbon clusters includes reacting a carbon oxide with a gaseous reducing agent in the presence of a metal having a predetermined grain size to cause growth of fibrous solid carbon clusters upon a surface of the metal. The carbon oxide and the gaseous reducing agent are in the presence of the metal for a predetermined time, at a predetermined temperature, and at a predetermined pressure. The fibrous solid carbon clusters are separated from the surface of the metal.

A reactor for producing solid carbon “forests” includes a metal catalyst, a means for facilitating the reduction of a carbon oxide to form solid carbon forests on a surface of the metal catalyst, and a means for removing the solid carbon forests from the surface of the metal catalyst.

Some methods of producing solid carbon forests include placing a catalyst surface in a reaction chamber, heating the catalyst surface in a reducing atmosphere for a predetermined conditioning time to a predetermined reaction temperature and a predetermined reaction pressure, and introducing a carbon-oxide-bearing gaseous reactant into the reducing atmosphere of the reaction chamber to form a reaction gas mixture. The catalyst surface is exposed to the reaction gas mixture for a predetermined exposure time to produce the solid carbon forests on the catalyst surface. The concentration of the reaction gases in the reaction gas mixture is maintained during the exposure time, and the concentration of water vapor in the reaction gas mixture is controlled to predetermined levels during the exposure time. The solid carbon forests are removed from the reaction chamber.

A method of producing carbon nanotubes of a preselected morphology includes conditioning a metal catalyst to obtain a surface structure of a desired chemical composition. The metal catalyst is introduced into a reactor, the reactor is purged of oxygen, a reducing gas flows into the reactor, and the metal catalyst is heated in the presence of the reducing gas to reduce metal oxides on a surface of the metal catalyst and provide a substantially oxygen-free surface having the desired chemical composition. A gaseous carbon oxide reacts in the presence of the metal catalyst and the reducing gas. At least one of reactor temperature, reactor pressure, reaction gas composition, and exposure time of the metal catalyst to the gaseous carbon oxide and the reducing gas are controlled to produce the selected carbon nanotube morphology.

Another method of producing carbon nanotubes includes providing a reducing gas in a reactor comprising a metal catalyst, heating the metal catalyst in the presence of the reducing gas to form a surface substantially of metal oxides, and reacting a carbon oxide in the presence of the metal catalyst to form carbon nanotubes. The carbon nanotubes are removed from the surface.

In certain embodiments hereof, the partial pressure of water in the reaction is regulated by various means, including recycling and condensation of water, to influence, for example, the structure or other aspects of the composition of carbon products produced. The partial pressure of water appears to assist in obtaining certain desirable carbon allotropes.

In certain embodiments, a broad range of inexpensive and readily-available catalysts, including steel-based catalysts, are described, without the need for activation of the catalyst before it is used in a reaction. Iron alloys, including steel, may contain various allotropes of iron, including alpha-iron (austenite), gamma iron, and delta-iron. In some embodiments, reactions disclosed herein advantageously utilize an iron-based catalyst, wherein the iron is not in an alpha phase. In certain embodiments, a stainless steel containing iron primarily in the austenitic phase is used as a catalyst.

Catalysts, including an iron-based catalyst (e.g., steel, steel wool), may be used without a need for an additional solid support. In certain embodiments, reactions disclosed herein proceed without the need for a ceramic or metallic support for the catalyst. Omitting a solid support may simplify the setup of the reactor and reduce costs.

### BRIEF DESCRIPTION OF THE DRAWINGS

Features and advantages of the disclosure will be apparent from reference to the following detailed description taken in conjunction with the accompanying drawings, in which:

FIG. 1 depicts a C—H—O equilibrium diagram;

FIG. 2 is a simplified block-flow diagram of a system for producing solid carbon products;

FIG. 3 is a simplified schematic of a reactor having sheets of catalyst material;

FIG. 4 is a simplified schematic of an experimental setup for the examples disclosed herein;

FIG. 5 is a side view of CNT “forest” growth of “pillow” morphology on a substrate produced as described in Example 1;

FIG. 6 is a top view of the forest of FIG. 5, shown at 700× magnification;

FIG. 7 is a top view of the forest of FIG. 5, shown at 18,000× magnification;

FIG. 8 shows an elemental analysis of the CNTs shown in FIGS. 5 through 7;

FIG. 9 shows a sample of CNTs at 10,000× magnification produced as described in Example 2;

FIG. 10 shows the sample depicted in FIG. 9, at 100,000× magnification;

FIG. 11 is a photograph of a stainless steel wafer with a CNT forest thereon, formed as described in Example 3;

FIG. 12 is an image of a region of the CNT forest of FIG. 11, at 2,500× magnification;

FIG. 13 is an image of the CNT forest of FIG. 11, at 10,000× magnification;

FIG. 14 is a photograph of steel wool produced as described in Example 4;

FIG. 15 is an image of a particle of the powder shown in FIG. 14, at 800× magnification;

FIG. 16 is an image of a particle of the powder shown in FIG. 14, at approximately 120,000× magnification;

FIG. 17 is a photograph of a stainless steel wire with a surface growth of graphite platelets, produced as described in Example 5;

FIG. 18 is an image of a graphite platelet shown in FIG. 17, at 7,000× magnification;

FIG. 19 is an image of a graphite platelet shown in FIG. 17, at 50,000× magnification;

FIG. 20 is a photograph of a stainless steel wafer with a fibrous growth of carbon nanotube “pillows,” produced as described in Example 6;

FIG. 21 is an image of the fibrous growth shown in FIG. 20, at 778× magnification, showing the “pillow” morphology as a substructure;

FIG. 22 is an image of a “pillow” shown in FIG. 20, at 11,000× magnification;

FIG. 23 is an image of a “pillow” shown in FIG. 20, at 70,000× magnification;

FIGS. 24 through 30 show samples of solid carbon at 50,000× magnification produced as described in Example 8;

FIGS. 31 through 38 show samples of solid carbon at 50,000× magnification produced as described in Example 9;

FIGS. 39 through 47 show samples of solid carbon at 50,000× magnification produced as described in Example 10;

FIGS. 48 through 54 show samples of solid carbon at 50,000× magnification produced as described in Example 11;

FIGS. 55 through 57 show samples of solid carbon at 50,000× magnification produced as described in Example 12;

FIGS. 58 through 62 show samples of solid carbon at 50,000× magnification produced as described in Example 13;

FIGS. 63 through 68 show samples of solid carbon at 50,000× magnification produced as described in Example 14;

FIG. 69 shows a sample of solid carbon at 12,000× magnification produced as described in Example 15;

FIG. 70 shows a sample of solid carbon at 8,000× magnification produced as described in Example 16;

FIG. 71 shows a sample of solid carbon at 10,000× magnification produced as described in Example 17;

FIG. 72 shows a sample of solid carbon at 5,000× magnification produced as described in Example 18;

FIGS. 73 and 74 show a sample of solid carbon at 800× and 10,000× magnification produced as described in Example 19;

FIGS. 75 and 76 show a sample of solid carbon at 5,000× and 10,000× magnification produced as described in Example 20;

FIGS. 77 through 82 show a sample of solid carbon at 250×, 800×, 1200×, 1600×, 2000×, and 3100× magnification, respectively, produced as described in Example 21; and

FIGS. 83 and 84 show a sample of solid carbon at 7,000× and 50,000× magnification produced as described in Example 22.

### MODE(S) FOR CARRYING OUT THE INVENTION

The methods involve the formation of solid carbon particles from carbon oxides. For example, fibrous CNT forests and solid carbon clusters of different shapes and morphologies may be formed from carbon oxides. The carbon oxides may be a product of combustion of a primary hydrocarbon, or carbon dioxide from the atmosphere, or carbon oxides from some other source. The carbon oxide and a reducing agent are injected into a preheated reaction zone, typically in the presence of a catalyst. The catalyst chemical composition, grain boundary, and grain size typically affect the morphology of the resulting solid carbon products.

Various carbon sources may be used, such as methane, ethane, propane, ethylene, propylene, carbon monoxide, and carbon dioxide. A hydrocarbon gas serves a dual function as both a carbon source and as a reducing agent for carbon oxides. The use of carbon monoxide or carbon dioxide may be advantageous because the methods disclosed herein convert such greenhouse gases to solid CNTs, which are a potentially valuable product. Thus, the method may be coupled with a combustion process or other processes that produce carbon dioxide, and methods may reduce the emissions of such gases from such processes.

Efficient, industrial-scale production of solid carbon products of various morphologies may be performed using carbon oxides as the primary carbon source. The type, purity, and homogeneity of the solid carbon product are typically controlled by controlling the reaction time, temperature and pressure of the reactor, the concentrations of various gases in the reactor, the size and method of formation of the catalyst, the chemical composition of the catalyst, and the form and shape of the catalyst. The methods are particularly useful for the formation of carbon nanotubes that grow substantially perpendicular to the catalyst surface and substantially parallel to each other.

One of the solid carbon morphologies of particular note are carbon nanotube forests or clusters. The term “carbon nanotube forest,” as used herein, refers to a group of carbon nanotubes substantially perpendicular to a catalyst surface and substantially parallel to each other. Thus, a carbon nanotube forest may be comprised of layers of carbon nanotubes that are substantially parallel to each other and that are substantially perpendicular to the catalyst surface over which they are formed. The carbon nanotube forests may also be substantially integrated, and individual nanotubes may cross and intertwine with each other as the nanotubes protrude from the catalyst surface.

The reaction conditions, including the temperature and pressure in the reaction zone, the residence time of the reaction gases, and the grain size, grain boundary, and chemical composition of the catalyst may be controlled to obtain solid carbon products of the desired characteristics. The feed gas mixture and reaction product are typically recycled through the reaction zone and passed through a condenser with each cycle to remove excess water and to control the partial pressure of the water vapor in the reaction gas mixture. The partial pressure of water is one factor that appears to affect the type and character (e.g., morphology) of solid carbon formed, as well as the kinetics of carbon formation.

Carbon activity (A_{c}) can be used as an indicator of whether solid carbon will form under particular reaction conditions (e.g., temperature, pressure, reactants, concentrations). Without being bound to any particular theory, it is believed that carbon activity is the key metric for determining which allotrope of solid carbon is formed. Higher carbon activity tends to result in the formation of CNTs, lower carbon activity tends to result in the formation of graphitic forms.

Carbon activity for a reaction forming solid carbon from gaseous reactants can be defined as the reaction equilibrium constant times the partial pressure of gaseous products, divided by the partial pressure of reactants. For example, in the reaction, CO_{(g)}+H_{2(g)} [symbol] C₍ₛ₎+H₂O_{(g)}, with a reaction equilibrium constant of K, the carbon activity A_{c} is defined as K·(P_{CO}·P_{H2}/P_{H2O}). The carbon activity of this reaction may also be expressed in terms of mole fractions and total pressure: A_{c}=K·P_{T}(Y_{CO}·Y_{H2}/Y_{H2O}), where P_{T} is the total pressure and Y is the mole fraction of a species. Carbon activity generally varies with temperature because reaction equilibrium constants vary generally with temperature. Carbon activity also varies with total pressure for reactions in which a different number of moles of gas are produced than are consumed. Mixtures of solid carbon allotropes and morphologies thereof can be achieved by varying the catalyst and the carbon activity of the reaction gases in the reactor.

The methods herein generally apply the Bosch reactions, such as the Bosch reaction of carbon dioxide with hydrogen to form solid carbon from carbon dioxide:

CO₂+2H₂ [symbol] C₍ₛ₎+2H₂O (Equation 1).

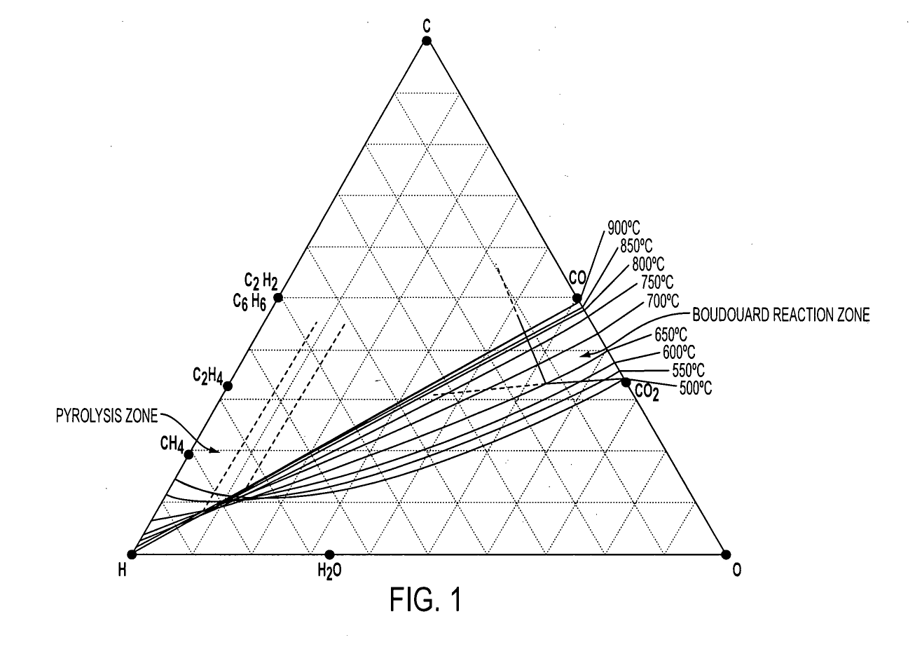

The type and quality of solid carbon produced typically vary based on the type of catalysts, gas mixtures, and process variables (e.g., temperature, pressure, concentration of reactants and retention times). Solid carbon forms in many different morphologies through the carbon oxide reduction process disclosed herein. Some of the solid carbon morphologies include graphite (e.g., pyrolytic graphite), graphene, carbon black, fibrous carbon, buckminsterfullerene, single-wall CNTs, multi-wall CNTs, platelets or nanodiamond. The reactions occur in the interior region of the triangular equilibrium diagram shown in FIG. 1.

The Bosch reactions use hydrogen or another reducing agent to reduce carbon oxides to solid carbon and water. The reactions proceed in the presence of a non-ferrous catalyst at temperatures in excess of approximately 650° C., such as in excess of about 680° C. When the solid carbon is in the form of CNTs, Equation 1 is exothermic (heat producing) and releases approximately 24.9 kcal/mol at 650° C. (i.e., ΔH=−24.9 kcal/mol). Equation 1 is reversible, wherein solid carbon is oxidized by water to form carbon dioxide. Although reaction temperatures above about 650° C. may be used to produce solid carbon nanotubes, if the temperature is too high, the rate of the reverse reaction of Equation 1 increases, and the net rate of reaction of carbon dioxide is lower. Through the process disclosed herein, carbon dioxide from various sources may be an economically valuable intermediate feedstock instead of an undesirable waste product with associated disposal costs.

The Bosch reactions are believed to be two-step reactions. In the first step of Equation 1, carbon dioxide reacts with hydrogen to create carbon monoxide and water:

CO₂+H₂ [symbol] CO+H₂O (Equation 2).

Equation 2 is slightly endothermic at 650° C., requiring a heat input of about 8.47 kcal/mol (i.e., ΔH=+8.47 kcal/mol). In the second step of the reaction shown in Equation 1, carbon monoxide reacts with hydrogen to form solid carbon and water:

CO+H₂ [symbol] C₍ₛ₎+H₂O (Equation 3).

Equation 3 may occur with stoichiometric amounts of reactants, or with excess CO₂ or H₂. Equation 3 is exothermic at 650° C., releasing 33.4 kcal/mol (1.16×10⁴ joules/gram of C₍ₛ₎) when CNTs are formed (i.e., ΔH=−33.4 kcal/mol). Values of ΔH for Equation 3 can be calculated for other carbon products by the difference between the ΔH value for Equation 1 for that particular carbon product and the ΔH value for Equation 2.

The Bosch reactions may be used to efficiently produce solid carbon products of various morphologies on an industrial scale, using carbon oxides as the primary carbon source. The Bosch reactions proceed at temperatures from about 450° C. to over 2,000° C. The reaction rates typically increase in the presence of a catalyst.

A reducing gas mixture of one or more commonly available hydrocarbon gases, such as lower hydrocarbon alkanes (e.g., methane, ethane, propane, butane, pentane, and hexane), including those found in natural gas, may be economical in some applications. In one embodiment, the reducing gas comprises methane and releases heat in an exothermic reaction in the presence of a catalyst. Methods disclosed herein may be coupled with a combustion process or chemical process that uses hydrocarbons, and a portion of the hydrocarbons of the process may be used as the reducing agent gas. For example, pyrolysis of the hydrocarbons may form a hydrogen gas that is provided as the reducing agent gas. When methane is used as a reducing gas and as a carbon source, the methane reacts with carbon dioxide to form solid carbon and water:

CH₄+CO₂ [symbol] 2C₍ₛ₎+2H₂O (Equation 4).

Equation 4 is believed to be a two-step reaction, including the following steps:

CH₄+CO₂ [symbol] 2CO+2H₂ (Equation 5); and

CO+H₂ [symbol] C₍ₛ₎+H₂O (Equation 6).

In the presence limited of oxygen, hydrocarbons react to form carbon monoxide, carbon dioxide, and water as well as small hydrocarbons and hydrogen. Higher concentrations of oxygen may limit the amount of solid carbon formed. Therefore, it may be desirable to restrict the amount of oxygen present in reaction systems to optimize the production of solid carbon. Additionally, the presence of oxygen may poison catalysts, thereby reducing the reaction rates. Thus, the presence of oxygen may reduce the overall production of solid carbon products. The reaction gases (e.g., the carbon oxide and the reducing agent gas) may be provided in near-stoichiometric ratios, as shown in Equations 1 through 6, to promote complete reaction.

The reactions described herein typically occur in the presence of a catalyst. Suitable catalysts include metals selected from groups 2 through 15 of the periodic table, such as from groups 5 through 10 (e.g., nickel, molybdenum, chromium, cobalt, tungsten, manganese, ruthenium, platinum, iridium, etc.), actinides, lanthanides, alloys thereof, and combinations thereof. For example, catalysts include iron, nickel, cobalt, molybdenum, tungsten, chromium, and alloys thereof. Note that the periodic table may have various group numbering systems. As used herein, group 2 is the group including Be, group 3 is the group including Sc, group 4 is the group including Ti, group 5 is the group including V, group 6 is the group including Cr, group 7 is the group including Mn, group 8 is the group including Fe, group 9 is the group including Co, group 10 is the group including Ni, group 11 is the group including Cu, group 12 is the group including Zn, group 13 is the group including B, group 14 is the group including C, and group 15 is the group including N. In some embodiments, commercially available metals are used without special preparation. The use of commercial forms of commonly available metals may reduce the cost, complexity, and difficulty of producing solid carbon. For example, CNT forests may grow on commercial grades of steel, with the CNT forests forming directly on the steel without additional layers or surfaces isolating the steel from the CNT forest. CNTs form on materials such as on mild steel, 304 stainless steel, 316L stainless steel, steel wool, and 304 stainless steel wire.

304 stainless steel appears to catalyze the formation of CNTs under a wide range of temperatures, pressures, and gas compositions. However, the rate of formation of CNTs on 304 stainless steel appears to be relatively low, such that 304 stainless steel may be used as a construction material, with minimal deposition on surfaces thereof in normal operations. 316L stainless steel, in contrast, appears to catalyze the formation of solid carbon at significantly higher rates than 304 stainless steel, but may also form various morphologies of carbon. Thus, 316L stainless steel may be used as a catalyst to achieve high reaction rates, but particular reaction conditions may be maintained to control product morphology. Catalysts may be selected to include Cr, such as in amounts of about 22% or less by weight. For example, 316L stainless steel contains from about 16% to about 18.5% Cr by weight. Catalysts may also be selected to include Ni, such as in amounts of about 8% or more by weight. For example, 316L stainless steel contains from about 10% to about 14% Ni by weight. Catalysts of these types of steel have iron in an austenitic phase, in contrast to alpha-phase iron used as a catalyst in conventional processes.

Various commercially available grades of metals may be used as catalysts, such as series-300 stainless steels, series-400 stainless steels, precipitation-hardened stainless steels, duplex stainless steels, and mild steels. In addition, various grades of chromium-, molybdenum-, cobalt-, tungsten-, or nickel-containing alloys or superalloys may be used, for example, materials commercially available from Special Metals Corp., of New Hartford, N.Y., under the trade name INCONEL®, or materials commercially available from Haynes International, Inc., of Kokomo, Ind., under the trade name HASTELLOY® (e.g., HASTELLOY® B-2, HASTELLOY® B-3, HASTELLOY® C-4, HASTELLOY® C-2000, HASTELLOY® C-22, HASTELLOY® C-276, HASTELLOY® G-30, HASTELLOY® N, or HASTELLOY® W). The catalyst may be in solid form, such as plates, cylinders, pellets, spheres of various diameters (e.g., as steel shot), or combinations thereof.

Catalysts can be formed from catalyst precursors, selected to decompose to form the desired catalyst. A supported catalyst is often prepared by combining precursors of the catalyst with a particulate support material. Suitable precursors include compounds that combust to form oxides of the desired catalyst. For example, if iron is the desired catalyst, some suitable precursors include iron(III) nitrate, iron sulfite, iron sulfate, iron carbonate, iron acetate, iron citrate, iron gluconate, and iron oxalate. The metal loading on the catalyst support may control the diameter of the solid carbon nanotube product formed on such catalysts.

In some embodiments, CNTs form without the use of a catalyst support. That is, CNTs form directly on commercially available grades of metal, thereby reducing the processing time and cost associated with CNT formation. Thus, a low-cost catalyst suitable for the production of fibrous CNT forests may be used to reduce carbon oxides and create CNTs.

The catalyst may be in the form of catalyst nanoparticles of the desired dimension or in the form of domains or grains and grain boundaries within the solid metal catalyst. As used herein, the term “grain size” refers to the mean, median, or mode grain diameter or width of the metal surface. Catalyst metals of a particular chemical composition may be selected wherein the grain size of the metal, for example, a grain of iron in a steel metal, has a characteristic dimension proportional to the diameter of the desired carbon nanotube. The distance between adjacent carbon nanotubes may be controlled by controlling the grain boundary of the solid metal catalyst.

During reduction of carbon oxides to form CNTs, such as in the reactions shown in Equations 1 through 6, above, each CNT formed may raise a particle of catalyst material from a surface of bulk catalyst material. Without being bound by any particular theory, it appears that the catalyst surface is slowly consumed by the formation of CNTs due to embedding a particle of the catalyst material into growth tips of the CNTs. The material on which a CNT grows may not be considered a catalyst in the classical sense, but is nonetheless referred to herein and in the art as a “catalyst,” because the carbon is not believed to react with the material. Furthermore, CNTs may not form at all absent the catalyst.

Solid catalysts may be designed or selected to promote formation of a selected solid carbon morphology. The catalyst may take many shapes and forms. For example, the catalyst may be in the form of plates, foil, cylinders, pellets, spheres of various diameters (e.g., steel shot), or combinations thereof. In some embodiments, commercially available sheet metal is used as the catalyst, and the sheet metal is layered to maximize the surface area of the catalyst, per volume of the reactor. A solid CNT forest may grow substantially perpendicular to a catalyst surface, regardless of the contour or shape of the catalyst. Consequently, CNT forests may form in many shapes and conformations by changing the shape or form of the catalyzing metal surface to a desired template.

The morphology of CNTs grown on metal catalyst typically depends on the chemistry of the metal catalyst and the way the catalyst was processed. For example, CNT morphology may be related to grain size and grain boundary shapes within the metal. For example, the characteristic size of these features influences the characteristic diameter of CNTs formed in the presence of such metal catalysts.

The grain size of a catalyst material may at least partially determine the size of the CNT product. Metals with smaller grain sizes may produce smaller diameter CNTs. For example, metals used as catalyst materials may have nano-sized structures. The grain size may be a function both of the chemistry of the metal catalyst and the heat-treating methods under which the grains are formed. For example, metals formed by cold rolling will have different grain sizes and grain boundaries than metals formed by hot rolling. Therefore, the method of metal formation have an effect on the solid carbon formed on the catalyst surface. Additionally, the grain boundary of the metal has an effect on the density and spacing of a CNT forest. Generally, larger grain boundaries of the catalyst metal surface correspond to CNTs spaced further apart.

In general, the grain structure of a metal surface may be changed by methods known in the art. For example, a metal structure may be heated to a temperature sufficient to recrystallize the metal structure to form multiple randomly oriented grains. Alternatively, the metal may be heat-treated or annealed to change the grain structure, grain boundary, and grain size. For example, the metal may be annealed by heating the metal to a temperature above its recrystallization temperature, maintaining the temperature for a period of time, then cooling the metal. As another example, metal may be annealed by heating it for a period of time to allow grains within the microstructure of the metal to form new grains through recrystallization.

Recrystallization is a process in which a metal is plastically deformed, annealed, or otherwise heat-treated. When the metal is heated, the heat-treatment affects grain growth in the metal structure. The size of a crystalline structure varies with the temperature above the critical temperature and the time at that temperature. Additionally, a faster cooling rate from the recrystallization temperature typically provides a larger maximum undercooling and a greater number of nucleation sites, thus producing a finer-grained metal. For example, when a finer mean grain size is desired, metal catalyst may be heated to a particular temperature and then rapidly cooled. In one embodiment, the CNT diameter and density of a fibrous CNT forest is controlled by selecting a metal catalyst based on the method of formation of the metal. For example, cold-rolled metals, hot-rolled metals, precipitation-hardened metals, annealed metals, case-hardened metals, tempered metals, or quenched metals may be selected as the catalyst depending on the desired morphology of the solid CNT forest.

The grain size and grain boundary of catalyst material may be changed to control the size and morphology of the solid carbon product. For example, catalyst material may be annealed at a temperature range from about 600° C. to about 1,100° C., from about 650° C. to about 1,000° C., from about 700° C. to about 900° C., or from about 750° C. to about 850° C. The resulting grain size may be from about 0.1 μm to about 50 μm, from about 0.2 μm to about 20 μm, from about 0.5 μm to about 5 μm, or from about 1.0 μm to about 2.0 μm. Various heat-treating, annealing, and quenching methods are known in the art of metal preparation, grain growth techniques, and grain refinement. Any of these methods may be used to alter the grain size and grain boundaries of the catalyst surface to control the size and morphology of the resulting solid carbon product.

When using a solid catalyst, such as a wafer of metal, CNTs appear to grow in a series of generations. Without being bound by any particular theory, it appears that reaction gases interact with an exposed surface of catalyst, and CNTs begin to grow on the surface. As the growth continues, neighboring CNTs become entangled and lift particles of the catalyst off the surface, exposing a new layer of catalyst material to the reaction gases. As each layer of catalyst material lifts off of the surface, the CNTs become entangled in clumps that resemble “pillows” or cockleburs under magnification. If a sample is left in the reaction zone, these layers continue to form and lift off the surface, and various structures composed of carbon nanotube “pillows” result.

A continuous-flow process may take advantage of the detachment of CNTs as a separation means. A solid CNT forest may easily be removed from the surface of the catalyst. Without being bound by any particular theory, carbon may act as a nucleating site for solid carbon. For example, carbon as a component of a catalyst material may promote the reaction. As the reaction continues and each layer of solid carbon is formed, newly formed carbon acts as a nucleating site for subsequent layers of solid carbon. Thus, in one embodiment, the size and morphology of the solid carbon product is controlled by selecting and controlling the carbon composition of the catalyst metal.

A catalyst composition in which catalyst layers are consumed during a reaction generally exposes fresh surfaces of catalyst, allowing for the formation of solid carbon products to continue uninterrupted. Without being bound by any particular theory, such a mechanism appears to occur, for example, when rusted steel is used as the solid metal catalyst.

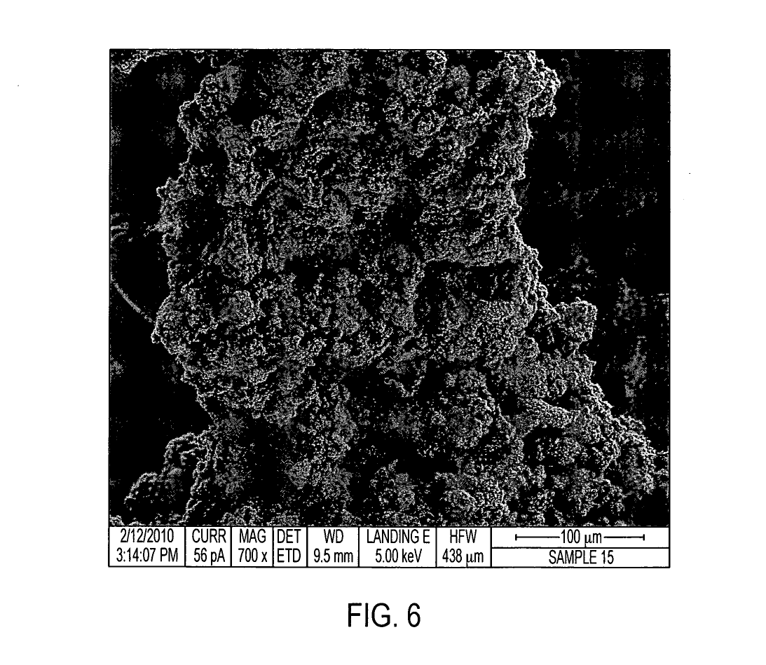

As depicted in, for example, FIGS. 6 and 21, pillow morphology is characterized by the presence of CNTs that are entangled in clusters. The pillows appear as bulbous or billowing conglomerations of nanotubes, similar to the appearance of the outer periphery of cumulus clouds. The pillows include carbon nanotubes of various diameters, lengths, and types. The pillows may appear in the form of discrete units in forests, piles, and fibers grown on a substrate. Metals of different compositions and forms yield carbon nanotube pillows under a wide range of reaction gas mixes and reaction temperatures.

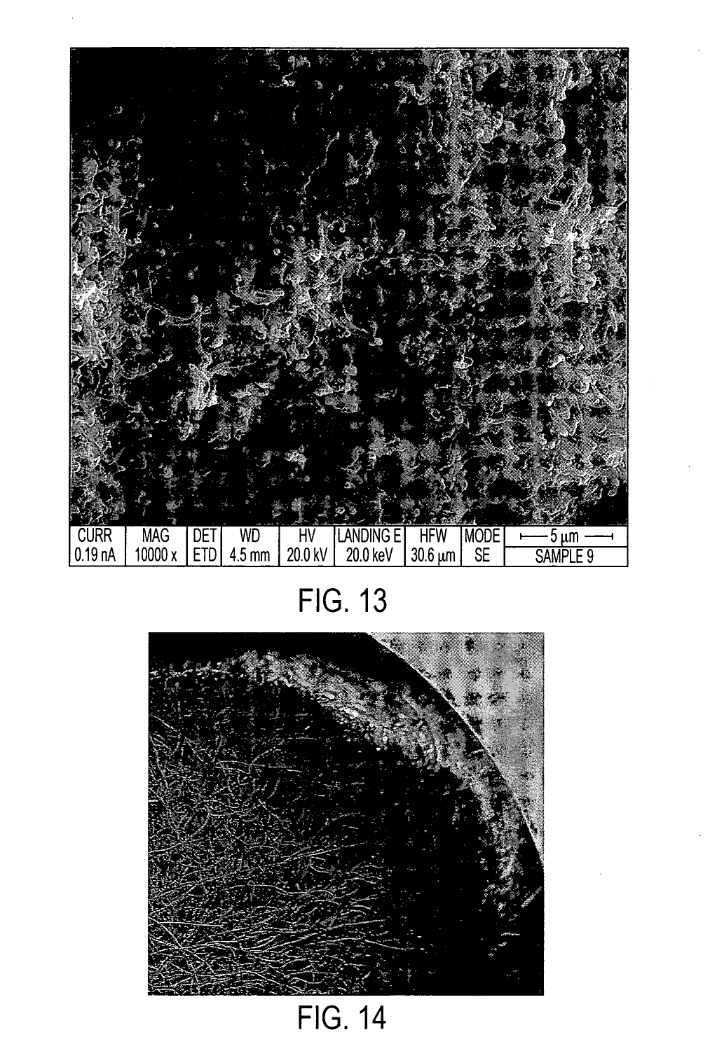

In some embodiments, sheet metal with perforations or thin slits is used as a catalyst. Perforations or cut-out slits in the sheet metal increase the catalyst surface area, thereby increasing the surface area of reactive catalyst surface per volume of catalyst. Perforations and slits may also be used to shape the formation and morphology of a CNT forest produced. In FIG. 13, the solid carbon nanotube formation resembles the structure of the catalyst. In some embodiments, the morphology and shape of the CNT forest are controlled by layering the catalyst, masking portions of the catalyst, and bending the catalyst to a selected shape.

Small amounts of substances (e.g., sulfur) added to the reaction zone may be catalyst promoters that accelerate the growth of carbon products on the catalysts. A catalyst promoter enhances the reaction rate by lowering further the activation energy for the reaction on the promoted surface. Such promoters may be introduced into the reactor in a wide variety of compounds. Such compounds may be selected such that the decomposition temperature of the compound is below the reaction temperature. For example, if sulfur is selected as a promoter for an iron-based catalyst, the sulfur may be introduced into the reaction zone as a thiophene gas, or as thiophene droplets in a carrier gas. Examples of sulfur-containing promoters include thiophene, hydrogen sulfide, heterocyclic sulfides, and inorganic sulfides. Other catalyst promoters include volatile lead (e.g., lead halides), bismuth compounds (e.g., volatile bismuth halides, such as bismuth chloride, bismuth bromide, bismuth iodide, etc.), ammonia, nitrogen, excess hydrogen (i.e., hydrogen in a concentration higher than stoichiometric), and combinations of these.

Heating catalyst structures in an inert carrier gas may promote the growth of specific structures and morphologies, such as single-wall CNTs. For example, helium may promote the growth of different structures or morphologies of the CNTs.

The physical properties of the solid carbon products may be substantially modified by the application of additional substances to the surface of the solid carbon. Modifying agents (e.g., ammonia, thiophene, nitrogen gas, and/or surplus hydrogen) may be added to the reaction gases to modify the physical properties of the resulting solid carbon. Modifications and functionalizations may be performed in the reaction zone or after the solid carbon products have been removed.

Some modifying agents may be introduced into the reduction reaction chamber near the completion of the solid carbon formation reaction by, for example, injecting a water stream containing a substance to be deposited, such as a metal ion. A catalyst-modifying agent is a material that alters the size of the metal clusters and alters the morphology of the carbon produced. Such substances may also be introduced as a component of a carrier gas. For example, surplus hydrogen appears to cause hydrogenation of a carbon lattice in some CNTs, causing the CNTs to have semiconductor properties.

Reaction temperatures depend on the composition of the catalyst or on the size of the catalyst particles. Catalyst materials having small particle sizes tend to catalyze reactions at lower temperatures than the same catalyst materials with larger particle sizes. For example, the Bosch reaction may occur at temperatures in the range of approximately 400° C. to 950° C., such as in the range of approximately 450° C. to 800° C., for iron-based catalysts, depending on the particle size and composition and the desired solid carbon product. In general, graphite and amorphous solid carbon form at lower temperatures, and CNTs form at higher temperatures. When the catalyst is mild steel, 304 stainless steel, 316L stainless steel, or steel wool, the growth of carbon nanotube forests is favored at temperatures above about 680° C.

In general, the reactions described herein proceed at a wide range of pressures, from near vacuum, to pressures of 4.0 MPa (580 psi) or higher. For example, solid carbon forms in pressure ranges of from about 0.28 MPa (40 psi) to about 6.2 MPa (900 psi). In some embodiments, CNTs form at pressures from about 0.34 MPa (50 psi) to about 0.41 MPa (60 psi), or at a pressure of about 4.1 MPa (600 psi). Typically, increasing the pressure increases the reaction rate.

The catalyst may be subjected to a reducing environment prior to contacting the catalyst surface with a carbon oxide. The reducing environment may activate the catalyst by reducing metal oxides on the surface of the catalyst to provide a non-oxidized catalyst surface. In some embodiments, a gaseous feedstock used to form CNTs, such as methane, is used to reduce oxides from the catalyst. Catalyst reduction may occur prior to, or concurrent with, contacting the catalyst with the carbon-containing feedstock to make CNTs.

The catalyst may be conditioned to change the chemical nature of the catalyst surface. As used herein, the term “chemical nature” means and includes the identity of the metal(s) of the catalyst, the state of oxidation or reduction, and the surface structure of the catalyst. Such conditioning is described in the following paragraphs.

Changing the grain size or the grain boundary may have an effect on the chemical and physical composition of the catalyst surface and may also change the shape and geometry of the catalyst surface. In some embodiments, the grain size and grain boundary of the catalyst surface are controlled by reducing the catalyst surface prior to the reaction. For example, a reducing gas mixture may be introduced into a reactor maintained at a selected temperature, pressure, and concentration to reduce the surface of the catalyst (i.e., to react with or remove oxidized materials).

The grain size and grain boundary of the catalyst material may be controlled by heating the catalyst surface and reducing any oxides at the surface. Maintaining the catalyst surface in a reducing environment for longer periods of time may result in relatively larger grain sizes, and shorter reducing treatments may result in relatively smaller grain sizes. Similarly, lower reducing temperatures may result in smaller grain sizes.

Oxidation and subsequent reduction of the catalyst surface alter the grain structure and grain boundaries. Without being bound by any particular theory, oxidation appears to alter the surface of the metal catalyst in the oxidized areas. Subsequent reduction may result in further alteration of the catalyst surface. Thus, the grain size and grain boundary of the catalyst may be controlled by oxidizing and reducing the catalyst surface and by controlling the exposure time of the catalyst surface to the reducing gas and the oxidizing gas. The oxidation and/or reduction temperatures may be in the range from about 500° C. to about 1,200° C., from about 600° C. to about 1,000° C., or from about 700° C. to about 900° C. The resulting grain size may range from about 0.1 μm to about 500 μm, from about 0.2 μm to about 100 μm, from about 0.5 μm to about 10 μm, or from about 1.0 μm to about 2.0 μm. In some embodiments, the catalyst may be an oxidized metal (e.g., rusted steel) that is reduced before or during a reaction forming solid carbon. Without being bound to any particular theory, it is believed that removal of oxides leaves voids or irregularities in the surface of the catalyst material, and increases the overall surface area of the catalyst material.

The grain boundary and the mean grain size of the catalyst surface can be controlled, for example, by sputtering (ion bombardment). As used herein, the term “sputtering” refers to the removal of atoms from a surface by the impact of an ion, neutral atoms, neutrons, or electrons. Sputtering generate surface roughness on the surface of the catalyst.

Grain boundaries formed by sputtering may be advantageous for the reduction reactions of carbon oxides. Sputtering may be used to remove atoms from the surface of the metal catalyst. The ion beam energy typically determines the resulting grain structure of the metal catalyst surface.

For example, in alloys or oxidized metal surfaces, the energy of the ion beam determines which atoms on the metal surface are removed. The energy applied during sputtering may be selected to remove only a particular atom in certain alloys. Thus, sputtering may result in a grain boundary having atoms or particles with relatively high surface-binding energies on the surface without atoms that removable by a low-energy ion beam. Increasing the ion beam energy removes atoms and particles with higher surface binding energies from the metal surface. Thus, sputtering may be used to produce surfaces having controlled grain boundaries, mean grain sizes, and grain patterns. Sputtering may be used to control the size and morphology of the solid carbon product by controlling the mean grain size, grain boundary, or grain patterns of the metal catalyst surface.

In some embodiments, the catalyst surface may be controlled by chemical etching to form a catalyst surface of a selected mean grain size and with a selected grain boundary. Etching processes include swabbing, immersion, spraying, or other methods. The type of etchant, the strength of the etchant, and the etching time affect the surface of the metal catalyst. For example, to etch a metal such as nickel-containing alloys or superalloys, a typical etchant includes a solution of 5 grams of copper(II) chloride (CuCl₂) with 100 ml of ethanol and 100 ml of hydrochloric acid. In some embodiments, nitric acid in various concentrations is used to etch catalysts. If a metal catalyst includes cobalt, the catalyst may be etched in a solution of iron(III) chloride (FeCl₃) in hydrochloric acid, which results in removing the cobalt. Thus, use of such an etchant selectively etches the cobalt from a cobalt alloy, leaving other metals on the surface of the catalyst. In this manner, the grain boundary of the surface may be selectively controlled, thereby enabling control of properties of the solid carbon product formed thereon. When the metal catalyst is steel, a typical etchant includes a solution of hydrochloric acid (HCl), glycerol (propane-1,2,3-triol), and nitric acid (HNO₃) in a 2:3:1 ratio. Other etchants for iron-containing metals include methanol or ethanol mixed with nitric acid in approximately a 9:1 ratio. In some embodiments, etchants include ethanol and picric acid, mixtures of hydrochloric acid, ethanol, water, and nitric acid.

Metals as described above may be used to catalyze the reduction of carbon oxides. In one embodiment, a fixed catalyst structure is disposed in a reactor in which reactant gases contact the catalyst to reduce a carbon oxide and create a CNT forest. Various reactor designs facilitate the formation and collection of desired solid carbon products.

In some embodiments, the catalyst material is commercially available sheet metal or foil, which may be very thin, so as to maximize the available surface area for reaction per unit volume of the reactor. The reactor may be configured to hold layers of the catalyst. The sheet metal or foil catalyst may be as thin as 0.0508 mm. For example, stainless steel sheet metal may have a thickness in a range from about 0.254 mm to about 19.05 mm or more. Stainless steel foil may be as thin as 0.0508 mm. The thickness of the catalyst may be determined based on the reactor configuration.

A reactor may be configured to optimize the catalyst surface area exposed to reactant gases, thereby increasing reactor efficiency, carbon oxide reduction, and solid carbon product formation. Such reactors may be operated continuously, semi-continuously, or in batch mode. In batch reactors, the catalyst either is a fixed solid surface or is mounted on a fixed solid surface (e.g., catalyst nanoparticles deposited on an inert substrate). The catalyst and the solid carbon grown thereon are periodically removed from the reactor.

A reactor may be coupled with heating and cooling mechanisms to control the temperature of the reactor. For example, a reactor may be configured such that products and excess reactant are recycled through a cooling mechanism to condense water vapor. The products and/or excess reactant may then be reheated and recycled through the reactor. By removing some of the water vapor in the recycled gases, the morphology of solid carbon formed may be controlled. Changing the partial pressure of water vapor changes the carbon activity of a mixture. The reactor may also be coupled to a carbon collector in which water and unreacted reactants are separated from the carbon products. The separated carbon products are collected and removed from the system.

Reactors may be operated such that reactant flow is characterized by laminar flow to optimize the contact time between the catalyst and the reactants. In such a configuration, a relatively brief period or a relatively small region of turbulent flow may assist in removal of solid carbon products from the catalyst surface.

Reactors may be sized and configured to increase the exposed catalyst surface area per unit volume of reactor. For example, if the catalyst is a thin sheet or foil, the foil may be coiled up in a spiral. Reactant gases may be distributed through a header or nozzle to direct the flow through the reactor. The reactant gas flow rate may be selected such that the reactant gases pass through the reactor in a laminar flow regime. If the catalyst is in a spiral formation, the gases may enter the reactor in the center of the catalyst spiral and exit the reactor at an outer wall of the reactor, such that approximately the entire catalyst surface is exposed to the reactant gases.

In some embodiments, two or more reactors operate together such that the overall process is semi-continuous. In such embodiments, solid catalyst material is placed and secured in each reactor. Each reactor is configured to be selectively isolated from the process while other reactors are in process. For example, each reactor may be configured with gas supply lines, purge lines, reactor outlet lines, and may be connected to a compressor. When sufficient solid carbon products have formed in one reactor to warrant removal, that reactor may be isolated from the system and taken offline, while another reactor is placed in operation. Solid carbon products are removed from the first reactor while solid carbon products are formed in the other reactor. After the solid carbon product is removed from the first reactor, the first reactor is prepared to again form solid carbon products. When sufficient solid carbon product has been formed in the second reactor, the second reactor is isolated and taken offline. A third reactor may be operated while the solid carbon product is removed and collected from the second reactor. In some embodiments, if the first reactor is ready for the reaction when the second reactor is ready to be taken offline, the first reactor may be placed back online. In this manner, the process operates in a semi-continuous fashion, and at least one reactor reduces a carbon oxide while at least another reactor is prepared to reduce a carbon oxide on the catalyst surface.

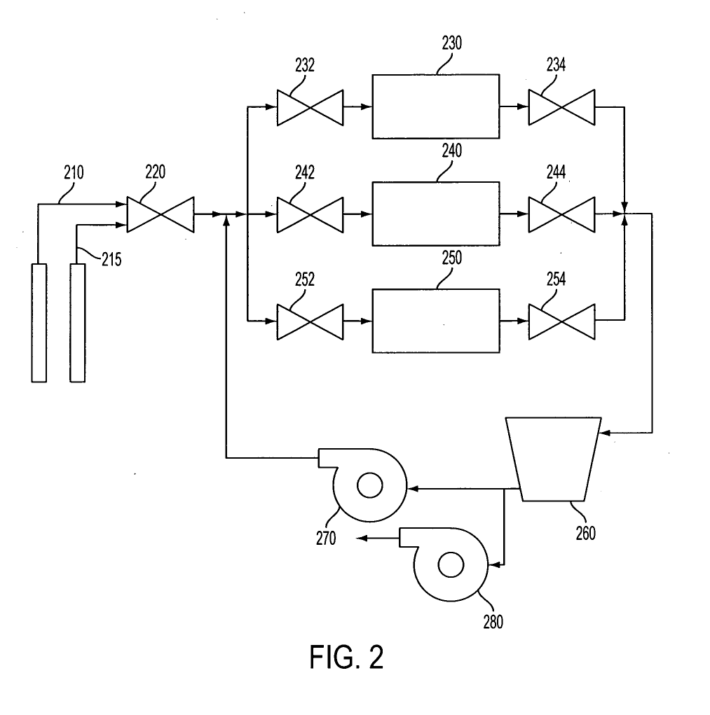

FIG. 2 shows a simplified block-flow diagram of a semi-continuous reaction system 200. A first reaction gas 210 is mixed with a second reaction gas 215 in a mixing valve 220. Reaction gases 210, 215 include a gaseous carbon oxide and a reducing agent, respectively. After passing through mixing valve 220, the reaction gases 210, 215 enter a first reactor 230 through an inlet valve 232. The reaction gases 210, 215 at least partially react within the first reactor 230 before leaving through an outlet valve 234.

After a period of time, the inlet valve 232 and the outlet valve 234 are closed, and the flow of reaction gases 210, 215 pass instead to a second reactor 240 via an inlet valve 242. The reaction gases 210, 215 at least partially react within the second reactor 240 before leaving through an outlet valve 244. As the reaction proceeds in the second reactor 240, the catalyst in the first reactor 230 may be prepared for a subsequent cycle of the reaction.

After a period of time, the inlet valve 242 and the outlet valve 244 are closed, and the flow of reaction gases 210, 215 pass instead to a third reactor 250 via an inlet valve 252. The reaction gases 210, 215 at least partially react within the third reactor 250 before leaving through an outlet valve 254. As the reaction proceeds in the third reactor 250, the catalyst in the first reactor 230 and/or the second reactor 240 are prepared for a subsequent cycle of the reaction.

As each cycle proceeds, the products (e.g., gases) enter a condenser 260 in which water vapor may be condensed and removed. Compressor 270 compresses remaining products and/or unreacted reactants and recycle them back to the mixing valve 220 or to any of the reactors 230, 240, or 250. A vacuum pump 280 purges the system 200 or reduces the pressure in the system 200.

Reactors may also be configured to operate continuously. If the reactor operates continuously, solid carbon products may be removed from the catalyst surface as the reaction continues. It appears that some reactions disclosed herein are conducive to operating reactors continuously because reaction gases interact with exposed surfaces of the catalyst as CNTs grow on the surfaces. As growth continues, a group of adjacent carbon nanotubes may become entangled and lift the CNTs off of the catalyst surface in layers, exposing a fresh catalyst surface to reaction gases to continue the reaction.

In some embodiments, a reactor is configured such that a continuous sheet, belt, or ribbon of catalyst metal is continuously transported through the reactor. When the sheet enters the reactor, the metal surface acts as a catalyst in the reduction of a carbon oxide. CNTs (or another form of solid carbon) form on the surface of the metal as the sheet is conveyed through the reactor. After passing through the reactor, the solid carbon product may be removed from the catalyst surface in preparation for another pass of the sheet through the reactor.

In some embodiments, the catalyst (e.g., in the form of a solid block, sheet metal, etc.) is placed or mounted on a conveyor belt. The conveyor belt passes through a reaction chamber and subsequently through a means of removing the solid carbon product from a surface of the catalyst. As the conveyor belt continues to move, the catalyst enters the reaction chamber again and the process repeats.

In some embodiments, flexible sheet metal or metal foil may be lined over the entire length of a conveyor belt. Thus, catalyst material may be continuously added to the reaction chamber and the solid carbon product may be continuously removed from the catalyst at another location. The reactor may be separated into different chambers or sections, such as a reducing chamber, where the carbon oxide is not present, and a catalytic chamber, where both the carbon oxide and reducing agent are present.

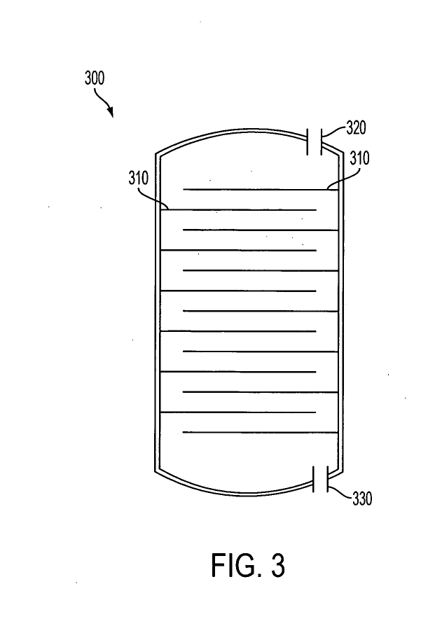

FIG. 3 shows a reactor 300 having several layers or sheets of catalyst material 310. The reactor 300 is configured such that reaction gases enter the top of the reactor 300 through an inlet 320 and exit at or near the bottom of the reactor 300 through an outlet 330. The catalyst material 310 may be configured in the reactor 300 such that as the reaction gases flow through the inlet 320 and the reactor 300, the reaction gases contact each surface of the catalyst material 310. If, as shown in FIG. 3, the inlet 320 is at the top of the reactor 300, the reaction gases contact the top sheet of catalyst material 310 and flow down through the reactor 300 in a tortuous path. As the reaction gases follow the tortuous path, the reaction gases contact each surface of catalyst 310 in the reactor 300. The layers or sheets of catalyst material 310 may be configured in the reactor 300 such that the reaction gases flow across the first layer at the top of the reactor 300, past the first layer at a wall of the reactor 300, passing over the top and bottom of every layer or sheet of catalyst material 310 in the reactor 300.

The solid carbon product is collected at the bottom of the reactor 300. The removal of the solid carbon product from the surface of the catalyst material 310 may be aided by the downward flow of reaction gases and by gravitational forces.

In other embodiments, a reactor contains one or more tubes of catalyst material (e.g., mild steel), and the reaction gases flow from the top of the reactor. The reaction gases contact the inner and outer surfaces of the tubes as the reaction gases flow downward toward the exit of the reactor.

If the catalyst is sheet metal or metal foil, the entire surface need not become coated with carbon. The carbon deposition area on the solid surface optionally may be limited to one or more regions by masking to promote formation of the solid carbon on only selected portions of the solid surface. Thus, masking may be used to alter the shape and morphology of the nanotube forest created.

Catalyst material may be removed from the reactor, and may be shaken or vibrated to remove solid carbon products from the surface. If the catalyst material is a tightly wound thin metal sheet or foil, the sheet or foil may be removed from the reactor and unwound, thereby causing the carbon product to flake off and separate from the catalyst surface. Alternatively, the reactor may be configured to vibrate the catalyst in situ, thereby removing the solid carbon product from the catalyst surface.

The solid carbon product may also be mechanically scraped off of the catalyst surface. For example, the catalyst may pass through a scraper designed with a clearance such that only the catalyst passes through, and the solid carbon product is scraped off of the catalyst surface. Alternatively, the catalyst may pass through a brush such that the solid carbon product is brushed off of the catalyst surface. The catalyst and solid carbon product may pass through a scraper, blade, or brush configured such that the catalyst surface passes under and is removed by the scraper, blade, or brush. Thus, the solid carbon product may be removed by scraping or otherwise abrading it off of the catalyst surface.

In another example, solid carbon products may be removed from a catalyst surface by directing high-velocity air or gas to an interface between the catalyst surface and the solid carbon product. For example, the solid carbon product may be removed from the catalyst surface by passing the catalyst through a reactor section configured to distribute a quick and powerful surge of high-velocity air to the catalyst surface, blowing the solid carbon product from the catalyst surface.

In some embodiments, solid carbon products may be rinsed off of a catalyst surface by a suitable solvent. For example, the solid carbon product may be removed by passing the conveyor through a reactor section configured to contact a solvent or acid with the solid carbon product, removing the solid carbon product from the surface of the catalyst. In some embodiments, solid carbon products may be chemically removed from catalyst surfaces by immersing the catalyst material in a solvent, such as ethanol. Some solid carbon formations may form into larger agglomerations. For example, if a sample of CNTs is gently stirred or shaken in ethanol, the CNTs agglomerate and interlock. The agglomerations may be larger and stronger than the individual pillow formations. The morphology of CNTs may be particularly suitable for forming various types of carbon nanotube paper, felts, electrodes, etc.

Removal of the solid carbon product from the catalyst surface may be coupled with means of separation and collection of a solid from a gas or liquid stream. Such means of collection may include, but are not limited to, elutriation, centrifugation, electrostatic precipitation, and filtration.

One or more substances may be introduced into the reaction zone to modify the physical properties of the desired solid carbon product either through incorporation in the solid carbon product, or by surface deposition on the solid carbon product. The physical properties of the solid carbon materials may be substantially modified by the application of additional substances to the surface of the solid carbon. Many different modifications and functionalizations of the resulting solid carbon are possible.

In one embodiment, after the solid carbon nanotubes have formed, the reaction gas mixture is removed from the reactor and replaced with a gas mixture for modifying or functionalizing the resulting solid carbon product. The carbon oxide and the reducing agent are removed from the reactor, and a functionalizing gas mixture is introduced into the reactor. The functionalizing gas mixture may include functional groups such as alkyl groups, carbonyl groups, aromatics, non-aromatic rings, peptides, amino groups, hydroxyl groups, sulfate groups, or phosphate groups. The reaction temperature and pressure are maintained at suitable conditions for the functionalization of the carbon nanotubes to take place. In another embodiment, after the solid carbon product is formed, the reactor is cooled with inert gases, air, or other gases or functional groups.

The reduction processes described herein generally result in the formation of at least one solid carbon product and water. The water may subsequently be condensed. Latent heat of the water may be extracted for heating purposes or as part of a low-pressure power extraction cycle. The water may be a useful co-product used for another process.

The methods disclosed herein may be incorporated into power production, chemical processes, and manufacturing processes in which the combustion of a primary hydrocarbon fuel source is the primary source of heat. The resulting combustion gases from such processes contain carbon oxides that may act as sources of carbon for the manufacture of the desired solid carbon product. The methods are scalable for many different production capacities so that, for example, plants designed with this method in mind may be sized to handle the carbon oxide emissions from the combustion processes of a large coal-fired power plant or those from an internal combustion engine. For example, the methods may be used to reduce carbon dioxide from the atmosphere, combustion gases, process off-gases, exhaust gases from the manufacture of Portland cement, and well gases, or from separated fractions thereof.

In another embodiment, the carbon oxides from a source gas mixture are separated from the source mixture and concentrated to form the carbon oxide feedstock for the reduction process. The carbon oxides in the source gases may be concentrated through various means known in the art (e.g., amine absorption and regeneration). In yet another embodiment, the catalytic conversion process may be employed as an intermediate step in a multi-stage power extraction process wherein the first stages cool the combustion gases to the reaction temperature of the reduction process for the formation of the desired solid carbon product. The cooled combustion gases, at the desired temperature of the reduction reaction, may then be passed through the reduction process and subsequently passed through additional power extraction stages.

Coupling this method with a hydrocarbon combustion process for electrical power production has an additional advantage in that the hydrogen required for the reduction process may be formed by the electrolysis of water using off-peak power. The oxygen formed in the electrolysis process

In some cases, it may be beneficial to remove the solid carbon product from the reaction gas mixture prior to cooling (e.g., by withdrawing the solid carbon product from the reactor through a purge chamber wherein the reaction gases are displaced by an inert purging gas such as argon, nitrogen, or helium). Purging prior to cooling helps reduce the deposit or growth of undesirable morphologies on the desired solid carbon product during the cooling process.

### EXAMPLES

The following examples illustrate the processes described. Each example is explained in additional detail in the following subsection, and scanning electron microscope images of the products of each of the examples are included.

TABLE 1
Conditions for Examples 1 through 7

| | Carbon | Reducing | | | | |
|---|---|---|---|---|---|---|
| Example | Oxide | Agent | Catalyst | Conditions | | |
| Example 1: | CO₂ | Hydrogen | rust | Pressure | = | 101.3 kPa |
| Multi-wall Carbon | | | on mild | Temp | = | 680° C. |
| Nanotube Pillows | | | steel | Time | = | 1 hour |
| Example 2: | CO₂ | Hydrogen | 304 | Pressure | = | 101.3 kPa |
| Multi-wall | | | stainless | Temp | = | 680° C. |
| Carbon Nanotubes | | | steel | Time | = | 1 hour |
| Example 3: | CO₂ | Hydrogen | 316L | Pressure | = | 97.3 kPa |
| Multi-wall | | | stainless | Temp | = | 700° C. |
| Carbon Nanotubes | | | steel | Time | = | 1 hour |
| Example 4: | CO₂ | Hydrogen | steel | Pressure | = | 70.6 kPa |
| Multi-wall | | | wool | Temp | = | 700° C. |
| Carbon Nanotubes | | | | Time | = | 1 hour |
| Example 5: | CO₂ | Hydrogen | 304 | Pressure | = | 78.5 kPa |
| Graphite | | | stainless | Temp | = | 575° C. |
| platelets | | | steel | Time | = | 2 hours |
| Example 6: | CO₂ | Hydrogen | 304 | Pressure | = | 101.3 kPa |
| Carbon Nanotube | | | stainless | Temp | = | 650° C. |
| Pillows | | | steel | Time | = | 1 hour |
| Example 7: | CO₂ | Hydrogen | mild | Pressure | = | 101.3 kPa |
| Carbon Nanotube | | | steel | Temp | = | 650° C. |
| Forests | | | tube | Time | = | 1 hour |

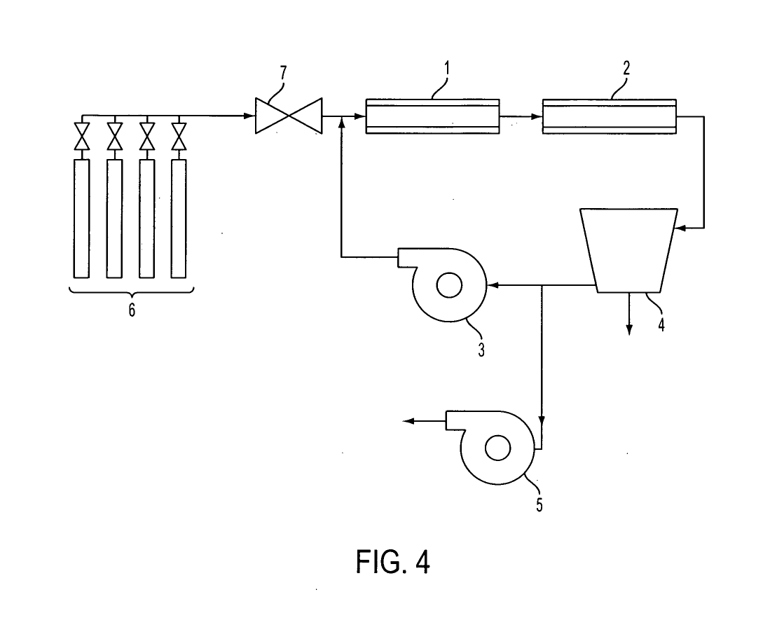

The laboratory setup for Examples 1 through 7 is illustrated in FIG. 4. The tests were performed in a batch mode. The experimental apparatus includes two tube furnaces 1, 2 connected in series. Each furnace included a quartz outer shell. The two-furnace arrangement allowed separate concurrent tests in each of the tube furnaces 1, 2 at different reaction temperatures and with different catalysts, but with the same reaction gas mixture and pressure. Catalyst samples (i.e., metal tubes) were placed inside the tube furnaces 1, 2. The tube furnaces 1, 2 were heated for approximately one to two hours, and, after the reaction, were cooled for four to six hours so that the samples could be removed. The tube furnaces 1, 2 may also operate independently with appropriate piping and valves. The components illustrated in FIG. 4, together with associated piping, instrumentation, and appurtenances are collectively referred to as the “experimental apparatus” in the following description of examples.

The gases used in various combinations in the examples were: research grade carbon dioxide (CO₂), available from PraxAir; research grade methane (CH₄), available from PraxAir; standard grade nitrogen (N₂), available from PraxAir; research grade helium (He), available from Air Liquide; and research grade hydrogen (H₂), available from PraxAir.

As depicted in FIG. 4, gases stored in a gas supply 6 passed through a mixing valve 7. The mixing valve 7 mixed the gases and controlled the flow of gases to the tube furnaces 1, 2. The gases flowed through the tube furnaces 1 and 2, to a condenser 4, generally maintained at about 3° C. to remove water. The dried gases passed through a compressor 3 and back into the tube furnace 1. A vacuum pump 5 was used intermittently to evacuate the tube furnaces 1, 2 if a particular experiment required purging the furnaces 1,2 with inert gases.

The temperature of the first tube furnace 1 was measured by a type-K thermocouple located inside the outer quartz shell at approximately the centerline of the first tube furnace 1. The temperature of the second tube furnace 2 was measured by a type-K thermocouple located at approximately the centerline of the second tube furnace 2 in a well drilled in the ceramic insulation of the tube furnace 2. The temperatures are reported as shown on these thermocouples.

No attempt was made to measure or to control the recirculation flow rate, and the quality of the product and speed of reaction seemed to be independent of flow rate (e.g., whether a high-volume compressor or a low-volume pump were used). Without being bound by any particular theory, the flow rates may have all been above a critical threshold. Flow rates may be important for design and operation of production facilities, but are not particularly important in the tests reported herein because the volume of the experimental apparatus was much larger than the volume of the catalyst and resulting solid carbon product. Appropriate tests to determine the optimum flow rates for a specific production design will readily occur to a skilled practitioner.

During the experiments, the pressure of the gases in the experimental apparatus would suddenly begin to rapidly drop as the temperature increased. The temperature at which the pressure began to drop varied with the catalyst and gas mixture. This drop in pressure may be an indication of the onset of formation of the solid carbon product. When the pressure dropped, additional reaction gases were added to the experimental apparatus via the mixing valve 7 to maintain pressure. After a short time, the pressure would begin to rise, at which point the mixing valve 7 was closed. The magnitude and duration of the pressure drop appear to be an indication of the onset of CNT growth and/or the rate of growth.

The start-up procedure followed one of two methods: heating the experimental apparatus in an inert gas (helium or nitrogen), or heating the experimental apparatus in air. In the case of heating in the inert gas, the experimental apparatus was evacuated and purged by the vacuum pump 5 for approximately five minutes, after which the vacuum pump 5 was turned off and isolated. The experimental apparatus was brought to atmospheric pressure with the inert gas. The inert gas was then turned off, and the heating elements of the tube furnaces 1, 2 were turned on to begin the heating cycle. In the case of air, the tube furnaces 1, 2 were not purged at start-up, and were simply brought up to operating temperature.

When the furnaces reached approximately the experimental set point temperature, the experimental apparatus was evacuated and purged with a reaction gas mixture (typically a stoichiometric mixture of carbon dioxide and reducing gas) for five minutes. The experimental apparatus was then brought to atmospheric pressure while the reaction gases and the temperature continued to rise and until the experimental apparatus gauge temperature was at the selected test temperature.

In the examples, the tube furnaces 1, 2 were operated for a fixed time (typically 1 hour), after which the tube furnaces 1, 2 were turned off. After the tube furnaces 1, 2 were turned off, the vacuum pump 5 was turned on, the reaction gases evacuated and the experimental apparatus purged with an inert gas (either helium or nitrogen) for approximately five minutes. Then the vacuum pump 5 was turned off and the experimental apparatus was brought up to atmospheric pressure with an inert purge gas and allowed to cool.

During the experiments, there were no observed differences in the quality of the CNTs produced based on the inert gas used for purging and cooling. Implementations of continuous flow reactors based on the examples herein will readily occur to a skilled practitioner.

### Example 1

A sample of mild steel wafer with extensive red rust spots was used as the catalyst. The mild steel wafer was placed in the tube furnace 1 at approximately the centerline. The vacuum pump 5 was started, and helium was used to purge the experimental apparatus for five minutes. After five minutes, the vacuum pump 5 was turned off, the compressor 3 was turned on, the refrigerated condenser 4 was turned on, and the helium gas continued to flow until the pressure reached 90.6 kPa (680 Torr), at which point the gas flow was shut off. The heating element of the tube furnace 1 was then turned on.

When the furnace 1 temperature reached a temperature of 680° C., the vacuum pump 5 was turned on, and reaction gases in a stoichiometric mixture of carbon dioxide and hydrogen (delivered from the gas supply 6 by the mixing valve 7) were used to purge the experimental apparatus for five minutes. After five minutes, the vacuum pump 5 was turned off. When the experimental apparatus reached a pressure of 101.3 kPa (760 Torr), the mixing valve 7 was closed to stop the flow of reaction gases into the tube furnace 1. The compressor 3 and the refrigerated condenser 4 were operating to circulate the reaction gases through the tube furnaces 1, 2. Additional reaction gases were added by periodically opening the mixing valve 7 to keep the experimental apparatus gauge pressure between 85.3 kPa (640 Torr) and 101.5 kPa (760 Torr). The reaction gases circulated through the tube furnaces 1, 2 for one hour, after which the heating element of the furnace 1 was shut off, the vacuum pump 5 was started, and the experimental apparatus was purged with helium for five minutes from gas supply 6 controlled by mixing valve 7. The vacuum pump 5 was then shut off and the helium purge gas continued to flow until the gauge pressure in the experimental apparatus was 98.7 kPa (740 Torr). The furnace 1 was then left to cool.

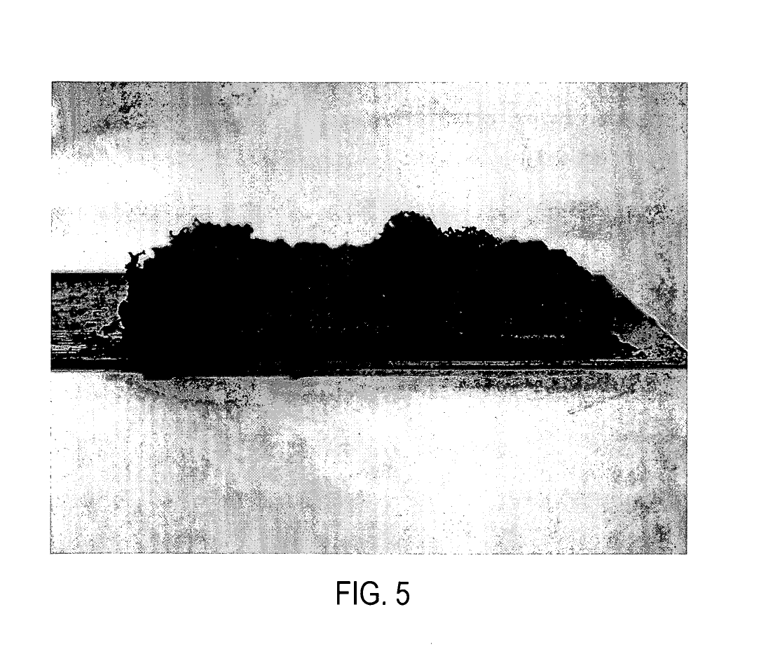

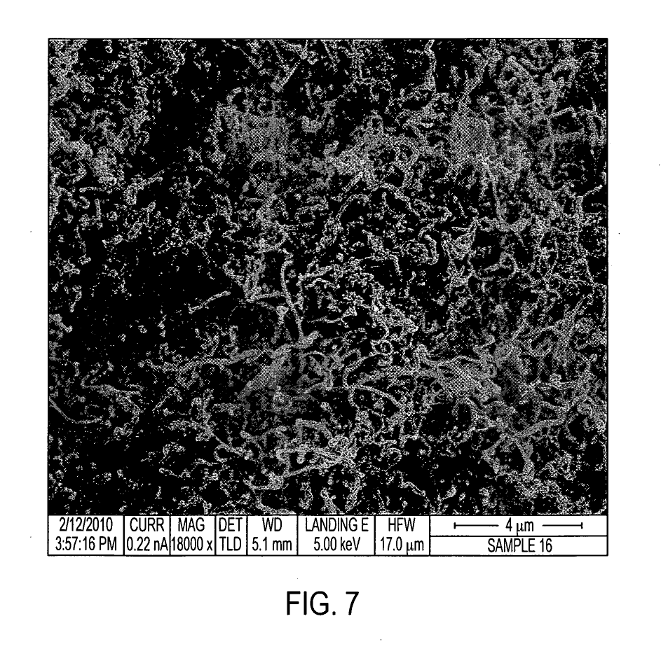

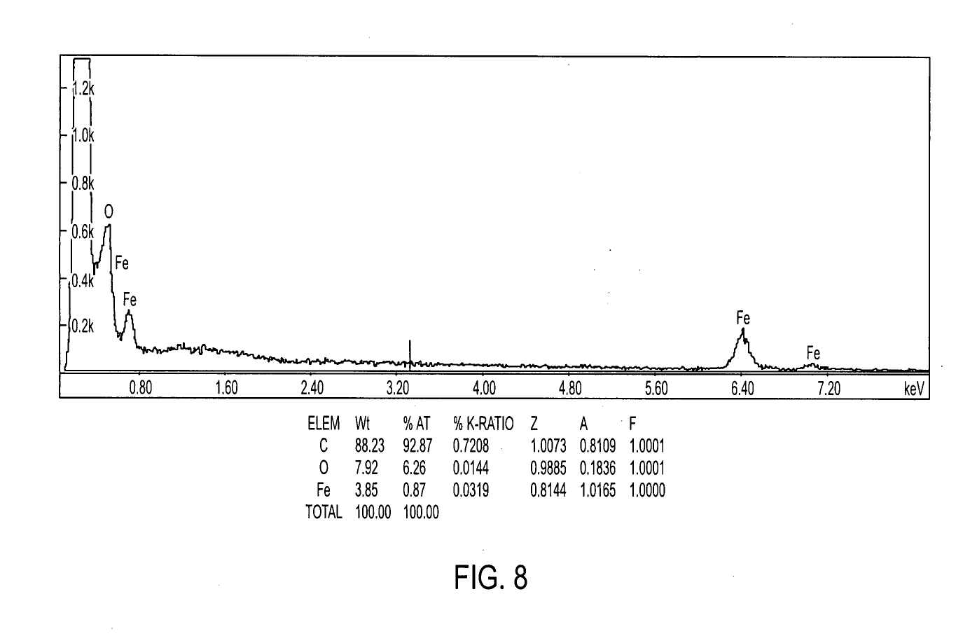

The steel sample was removed after the furnace 1 had cooled. FIG. 5 shows a photograph of the steel sample after it was removed, including a “forest” type of growth on the substrate. This forest is comprised of CNT “pillows.” FIG. 6 shows an SEM (scanning electron microscope) image of the same sample under 700× magnification. FIG. 7 is a top view and shows the same sample of FIG. 6 under 18,000× magnification and shows the details of a typical pillow. The size of the CNTs (tens to hundreds of nanometers in diameter) indicates that they are probably multi-wall CNTs. FIG. 7 also shows the catalyst in the growth tip end of each CNT at bright spots. The average diameter of the growth tip appears to be approximately 1.2 to 1.3 times the diameter of the associated carbon nanotube. FIG. 8 shows an elemental analysis of the CNTs in FIG. 7, indicating that the CNTs are primarily carbon with minor iron and oxygen constituents, perhaps due to the catalyst particles embedded in the growth tips of the CNTs.

### Example 2

A quartz disk was placed lying flat on a wafer of 304 stainless steel, which was used as the catalyst. The wafer was placed in furnace 1 at approximately the centerline. The experimental apparatus was helium-purged and heated as in Example 1. Reaction gases were added and recirculated for one hour at a temperature of 680° C. and a pressure between 85.3 kPa (640 Torr) and 101.3 kPa (760 Torr), as in Example 1.

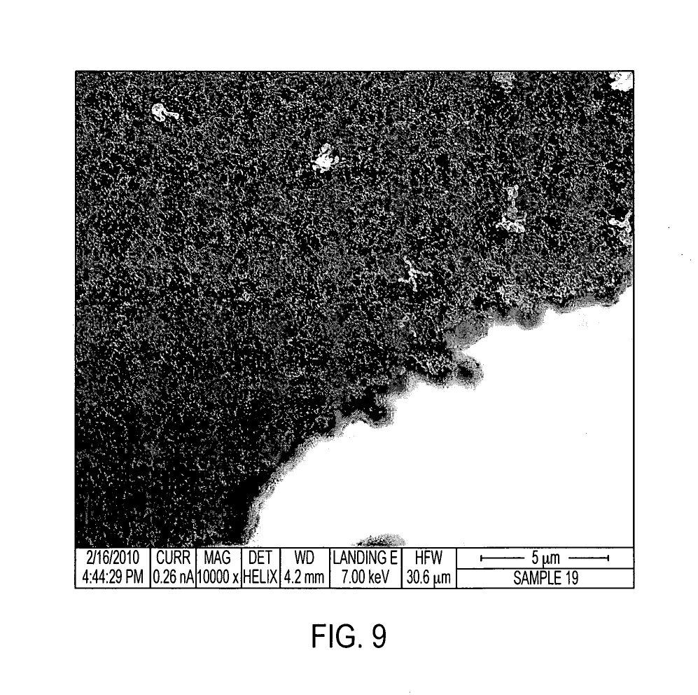

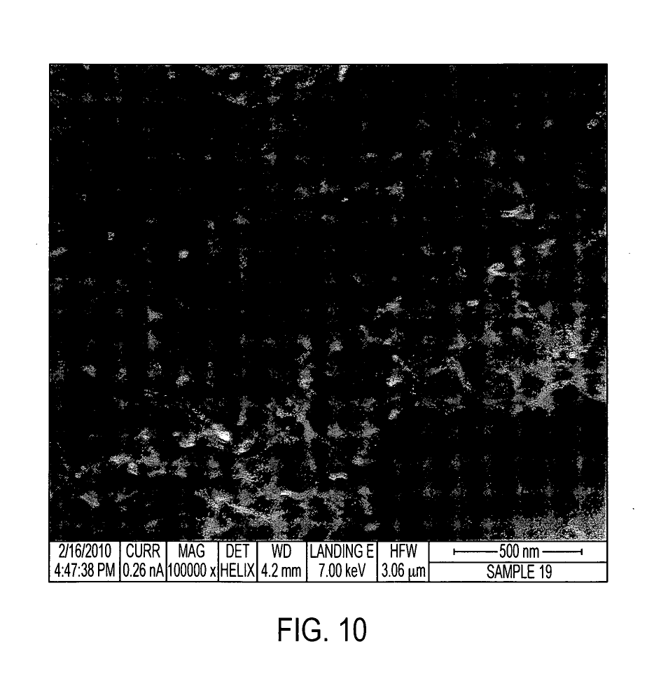

The stainless steel sample was removed from the furnace 1 after the furnace 1 had cooled. A mat of CNTs had grown between the quartz and the stainless steel wafer. Portions of the CNT mat adhered to both the quartz and the stainless steel surfaces. FIG. 9 shows the sample under 10,000× magnification, and FIG. 10 shows the sample under 100,000× magnification. The size of the CNTs (tens to hundreds of nanometers in diameter) indicates that they are probably multi-wall CNTs.

### Example 3

A wafer of 316L stainless steel was used as the catalyst. The 316L stainless steel wafer was placed in furnace 1 at approximately the centerline. The experimental apparatus was helium-purged and heated as in Example 1. Reaction gases were added and recirculated for one hour as in Example 1, but at a temperature of 700° C. and a pressure between 93.3 kPa (700 Torr) and 97.3 kPa (730 Torr).

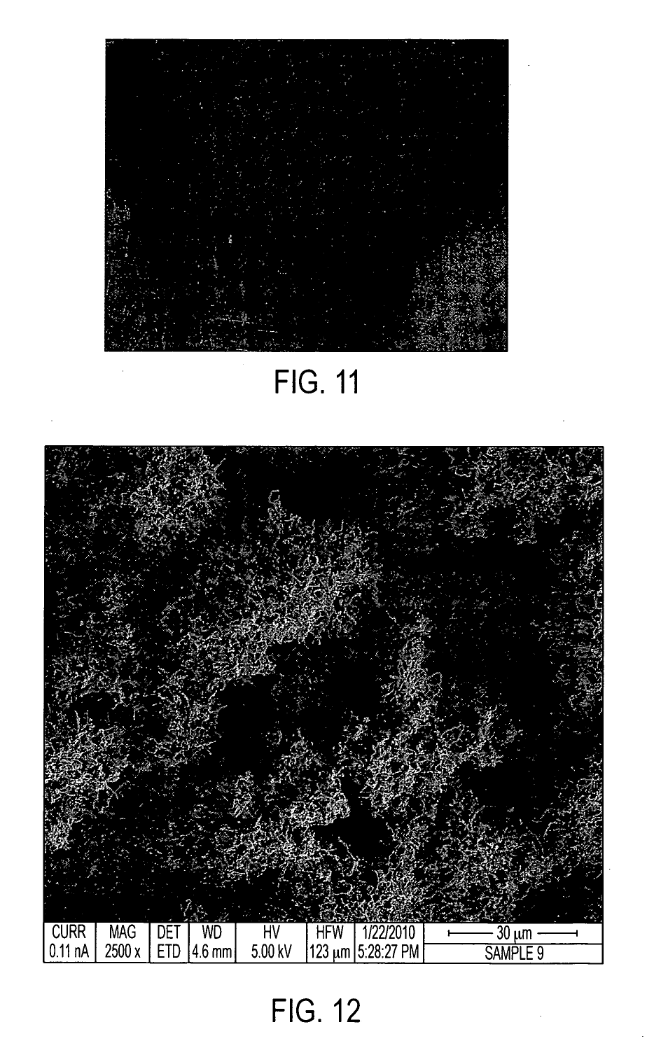

The stainless steel wafer was removed from the furnace 1 after the furnace 1 had cooled. FIG. 11 is a photograph of the stainless steel wafer. The carbon nanotubes grew on only a portion of the wafer. The reasons for this are unclear. FIG. 12 shows an image of a region of the CNT forest on the wafer at 2,500× magnification, and FIG. 13 shows an image of the same region of the CNT forest at 10,000× magnification. The diameter of the tubes indicates that they are likely multi-wall CNTs.

### Example 4

A sample of mild steel wool was used as the catalyst. The steel wool was placed in the furnace 1 near the centerline and heated in air. The compressor 3, the refrigerated condenser 4, and the heating element of the tube furnace 1 were turned on, circulating air through the experimental apparatus. When the furnace 1 temperature reached 645° C. the vacuum pump 5 was started, and a stoichiometric mixture of carbon dioxide and hydrogen flowed from the gas supply 6 (via the mixing valve 7) into the tube furnace 1 for five minutes. The temperature of the furnace 1 continued to increase to a set point of 700° C. At the end of five minutes, the vacuum pump 5 was shut off and the gases continued to flow until the gauge pressure of the experimental apparatus was 70.6 kPa (530 Torr), at which point the reaction gas flow rate was reduced to a lower flow rate sufficient to keep the pressure between 66.6 kPa (500 Torr) and 70.6 kPa (530 Torr). The reaction gases circulated through the tube furnaces 1, 2 for one hour, after which the heating element of furnace 1 was shut off, the vacuum pump 5 was started, and the experimental apparatus was purged with helium for five minutes. The vacuum pump 5 was then shut off; and the helium purge gas continued to flow until the gauge pressure in the experimental apparatus was 93.3 kPa (700 Torr). The furnace 1 was then left to cool.

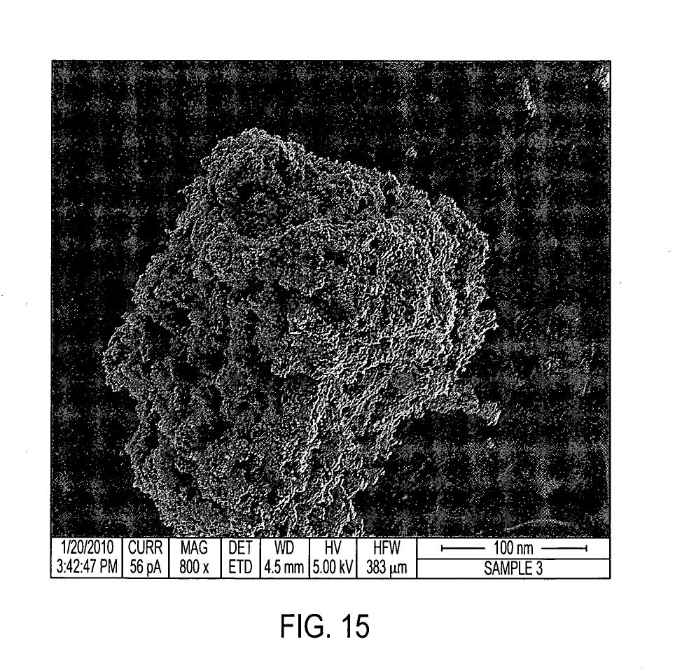

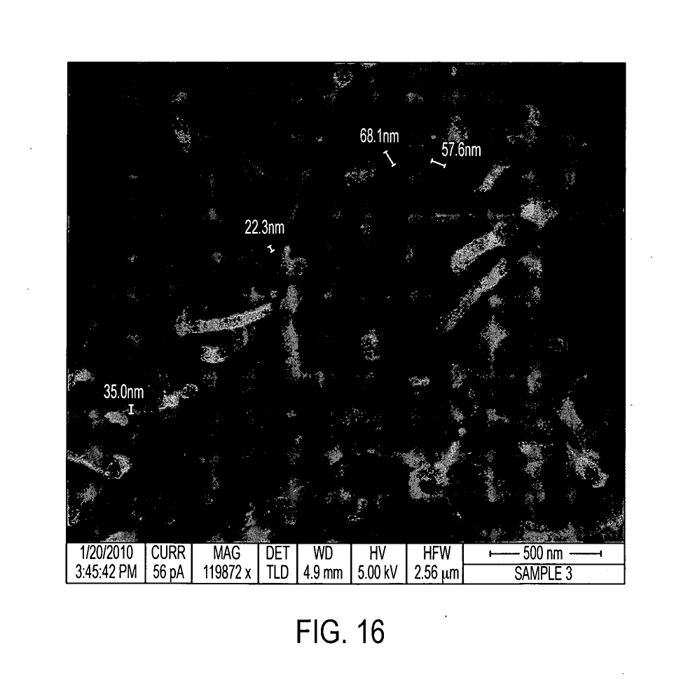

The steel wool sample with the solid carbon product was removed after the furnace 1 had cooled. FIG. 14 is a photograph of the steel wool sample. The powdery black band of solid carbon product was sampled and examined under SEM, shown in an image of a particle of the powder at 800× magnification in FIG. 15. The depicted particle is a single “pillow” of the pile of pillows comprising the powdery black band. FIG. 16 shows an image of the same pillow at approximately 120,000× magnification. The diameter indicates that the CNTs are likely multi-wall.

### Example 5

A sample of 316 stainless steel wire was used as the catalyst. The wire was placed in the furnace 1 near the exit of the furnace 1. The heating element of the furnace 1, the refrigerated condenser 4, and the vacuum pump 5 were turned on. Reaction gases in a stoichiometric mixture of carbon dioxide and hydrogen (delivered from the gas supply 6 by the mixing valve 7) were used to purge the experimental apparatus for five minutes. After five minutes, the vacuum pump 5 was turned off, the compressor 3 was turned on, and the reaction gas mixture continued to flow until the gauge pressure of the experimental apparatus was 78.5 kPa (589 Torr), at which point the reaction gas flow was shut off. The reaction gases circulated through the tube furnaces 1, 2 for two hours at 575° C., after which the heating element of the furnace 1 was shut off, the vacuum pump 5 was started, and the experimental apparatus was purged with helium for five minutes. The vacuum pump 5 was then shut off, and the helium continued to flow until the gauge pressure in the experimental apparatus was 93.3 kPa (700 Torr). The furnace 1 was then left to cool.

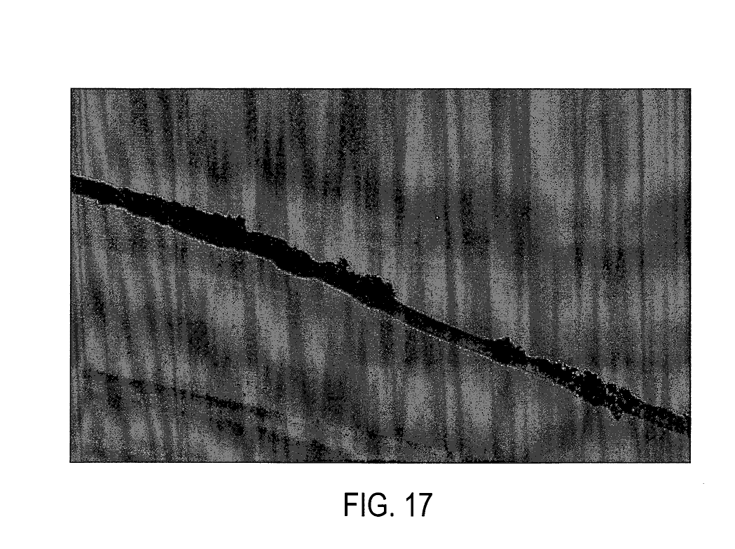

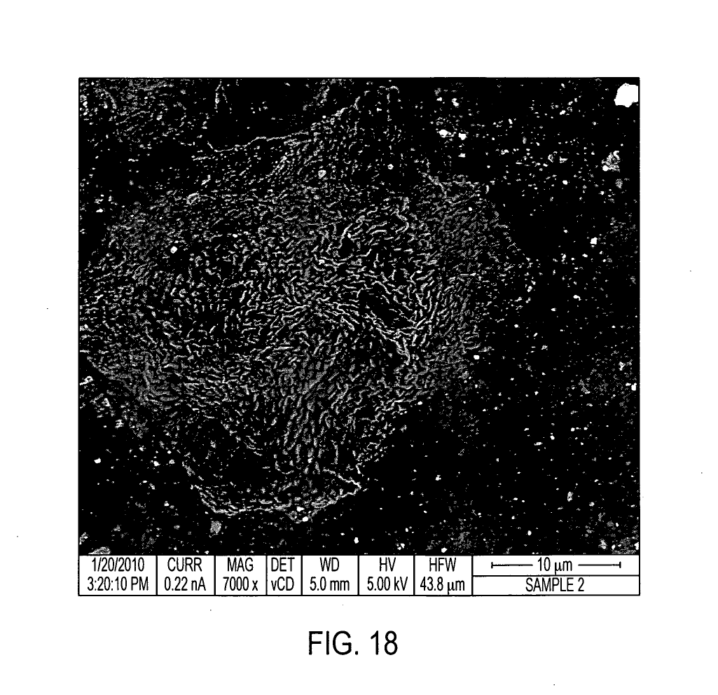

The steel wire was removed from the furnace 1 after the furnace 1 had cooled. FIG. 17 is a photograph of the steel wire sample with the surface growth of the solid carbon product, which in this example, includes graphite platelets. Samples of the graphite platelets were imaged using SEM, as shown in FIG. 18 at 7,000× magnification and in FIG. 19 at 50,000× magnification.

### Example 6

A wafer of 304 stainless steel was used as the catalyst. Quartz discs were place on the upper surface of the stainless steel wafer. The stainless steel wafer and quartz discs were placed in the furnace 1 at approximately the centerline. The experimental apparatus was helium-purged and heated as in Example 1. Reaction gases were added and recirculated at a temperature of 650° C. and a pressure between 85.3 kPa (640 Torr) and 101.3 kPa (760 Torr), as in Example 1.

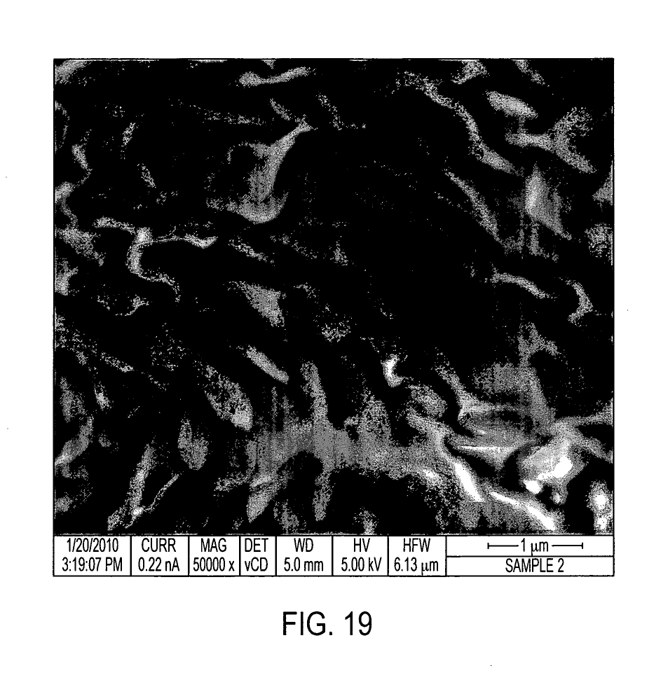

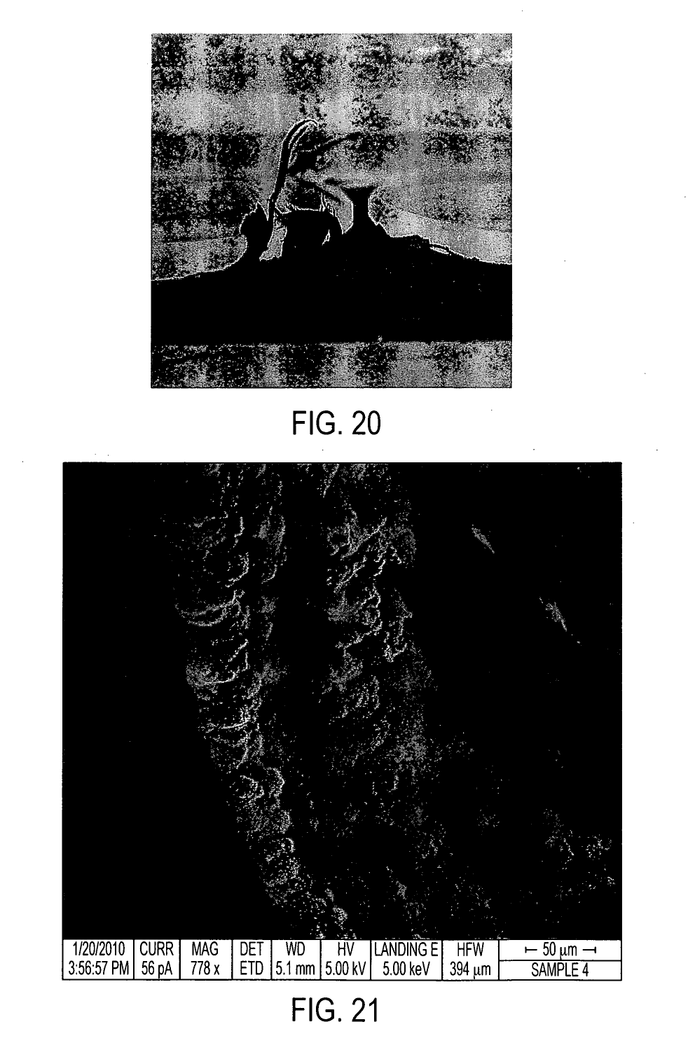

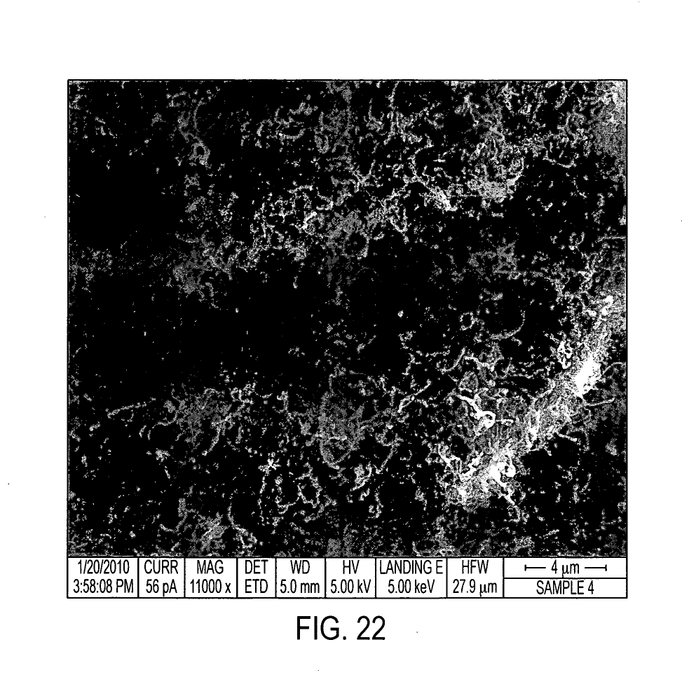

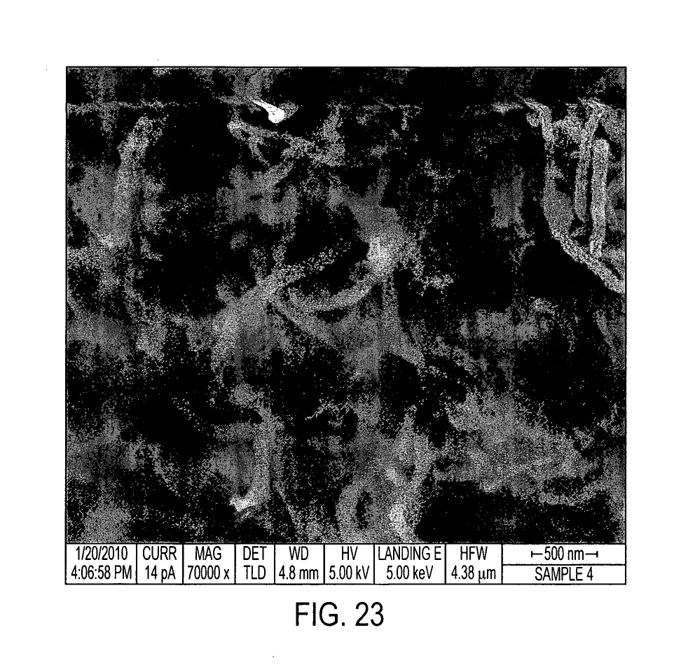

The stainless steel wafer and quartz discs were removed after the furnace 1 had cooled. FIG. 20 is a photograph of the sample with graphite platelets on a surface. Samples of the graphite platelets were imaged using SEM, as shown in FIG. 21 at 778× magnification. FIG. 21 shows pillows comprising the fibers. FIG. 22 shows one of the pillows at 11,000× magnification including the entangled structure of the carbon nanotubes. FIG. 23 shows a 70,000× magnification showing the detail of some of the carbon nanotubes of the same pillow as is shown in FIG. 22.

Substitution of the catalyst in the previous examples with catalysts comprised of groups 5 through 10 of the periodic table (e.g., nickel, molybdenum, chromium, cobalt, tungsten, manganese, ruthenium, platinum, iridium, etc.), actinides, and lanthanides may yield substantially similar results. Thus, substitution of catalyst with a chromium-, molybdenum-, cobalt-, tungsten-, or nickel-containing alloy or superalloy may yield a substantially similar result, with the size and morphology of the nanotube product dependent on the grain size of the catalyst material. Suitable catalysts also include mixtures of such metals. Similar reaction conditions as those described herein may be used with such catalysts. For example, the reaction temperature may range from about 500° C. to about 1,200° C., from about 600° C. to about 1,000° C., or from about 700° C. to about 900° C. In some embodiments, the temperature may be at least 650° C., such as at least 680° C., to produce a selected solid carbon product. The size and morphology of the solid carbon product (e.g., CNTs) may depend on the grain size of the non-ferrous catalyst.

### Example 7

A mild steel tube having a length of about 15 cm and an inner diameter of about 5 cm was placed in the furnace 1 at approximately the centerline. Reaction gas flow was directed from the top of the reactor downward, which aided in the collection of the solid carbon product. When the furnace 1 reached a set point of 650° C., the carbon deposition rate was about 8.0 g/hr on the steel tube. The deposition rate did not appear to be a strong function of the temperature in the temperature range in which carbon is deposited on the surface of the steel tube. The carbon formation rate was equivalent to approximately 7.61×10⁻³ moles/m²/s, which is similar to the rate of mass transfer for the pipe.

For Examples 8 through 14, below, carbon steel coupons were cut from a sheet of steel having a thickness of about 1.3 mm. Each coupon was approximately 13 mm wide and approximately 18 mm to 22 mm long. Coupons were separately placed in quartz boats about 8.5 cm long and 1.5 cm wide, and the boats were inserted end-to-end into a quartz tube having an inner diameter of about 2.54 cm and a length of about 1.2 m. The quartz tube was then placed in a tube furnace. The quartz tube was purged with hydrogen gas to reduce the surfaces of the coupons before the tube furnace was heated to operating conditions. After the tube furnace reached operating conditions, reaction gases were introduced into the quartz tube (i.e., flowed continuously through the quartz tube) such that both the upper and lower surfaces of each coupon were exposed to reaction gas. The temperature, pressure, and gas composition were measured at each coupon. After the test, the coupons were removed from the quartz tube. Weight changes and carbon formation were noted.

### Example 8

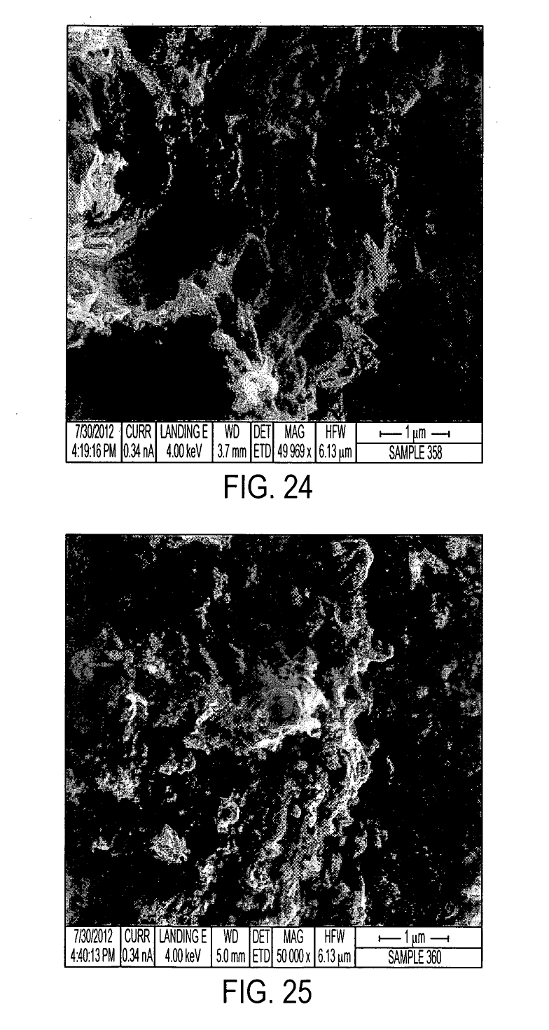

Twelve steel coupons were placed in a quartz tube as described above. A reaction gas containing about 25% H₂, 25% CO, 25% CO₂, and 25% CH₄ was introduced into the quartz tube at about 4.0 MPa. The gases flowed over the coupons for about 4 hours at 2000 sccm (standard cubic centimeters per minute). Solid carbon formed on eight of the twelve coupons at temperatures between about 650° C. and about 870° C., as shown in Table 2 below. After the test, solid carbon was physically removed from some of the coupons and tested for BET specific surface area, as shown in Table 2. Samples of the solid carbon were imaged using SEM, as shown in FIGS. 24 through 30 at 50,000× magnification. About 41.2 grams of water was collected from the gases during the test.

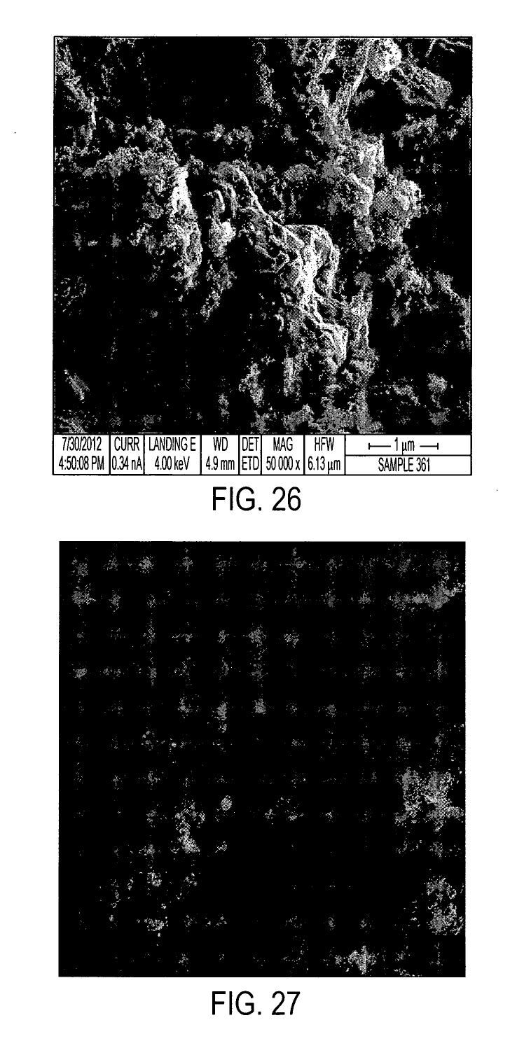

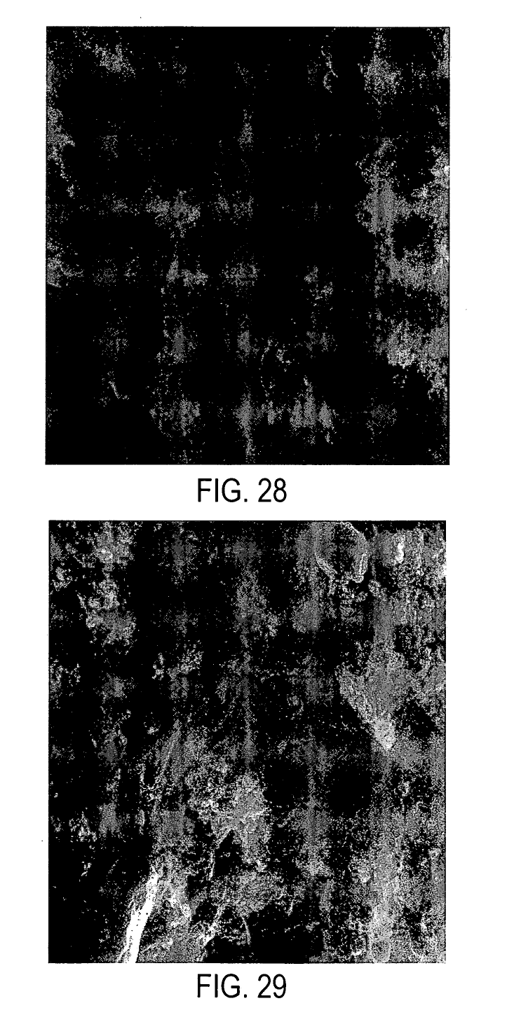

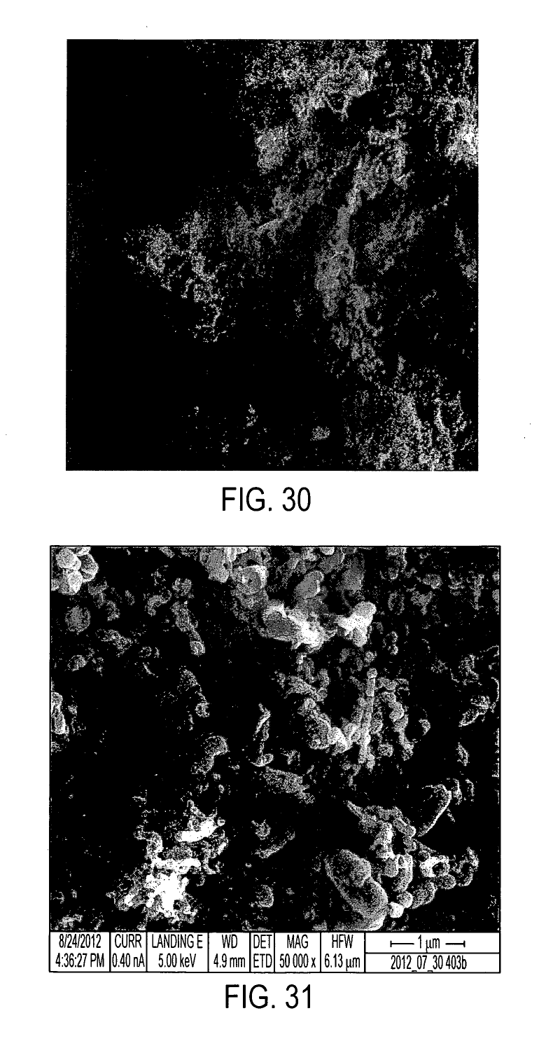

TABLE 2
Solid Carbon Formation from 25% H₂, 25% CO, 25% CO₂, and 25% CH₄

| | Sample # | | | | | |
|---|---|---|---|---|---|---|
| | 1 | 2 | 3 | 4 | 5 | 6 |
| Distance from inlet (inches) | 5.3 | 8.6 | 12.1 | 15.9 | 19.2 | 23.3 |
| Temperature (° C.) | 358.4 | 563.3 | 649.4 | 701.5 | 721.4 | 749.9 |
| H₂ composition (%) | | | 23.7 | | 22.6 | 21.9 |
| CH₄ composition (%) | | | 24.9 | | 24.4 | 24.1 |
| CO₂ composition (%) | | | 23.0 | | 21.4 | 20.5 |
| CO composition (%) | | | 26.1 | | 27.2 | 27.9 |
| H₂O composition (%) | | | 2.39 | | 4.46 | 5.67 |
| Deposition rate (g/cm²/hr) | 0.000 | 0.000 | 0.058 | 0.043 | 0.047 | 0.109 |
| Surface Area (m²/g) | | | 249.5 | 178.7 | 141.3 | |
| SEM image | | | FIG. 24 | | FIG. 25 | FIG. 26 |
| | Sample # | | | | | |
| | 7 | 8 | 9 | 10 | 11 | 12 |
| Distance from inlet (inches) | 26.9 | 30.3 | 33.7 | 37.2 | 40.4 | 44.0 |
| Temperature (° C.) | 773.4 | 802.5 | 842.0 | 892.2 | 868.8 | 548.4 |
| H₂ composition (%) | 21.3 | 20.8 | 20.2 | | 19.2 | |
| CH₄ composition (%) | 23.9 | 23.6 | 23.4 | | 22.9 | |
| CO₂ composition (%) | 19.6 | 18.9 | 18.1 | | 16.5 | |
| CO composition (%) | 28.5 | 29.0 | 29.6 | | 30.7 | |
| H₂O composition (%) | 6.71 | 7.70 | 8.71 | | 10.7 | |
| Deposition rate (g/cm²/hr) | 0.116 | 0.107 | 0.085 | 0.000 | 0.043 | 0.000 |
| Surface Area (m²/g) | 110.4 | 97.5 | 97.5 | | 106.4 | |
| SEM image | FIG. 27 | FIG. 28 | FIG. 29 | | FIG. 30 | |

### Example 9

Twelve steel coupons were placed in a quartz tube as described above. A reaction gas containing about 50% CO and 50% CO₂ was introduced into the quartz tube at about 4.0 MPa. The gases flowed over the coupons for about three hours at 2000 sccm. Solid carbon formed on ten of the twelve coupons at temperatures between about 590° C. and about 900° C., as shown in Table 3 below. After the test, solid carbon was physically removed from some of the coupons and tested for BET specific surface area, as shown in Table 3. Samples of the solid carbon were imaged using SEM, as shown in FIGS. 31 through 38 at 50,000× magnification. No water was collected from the gases during the test.

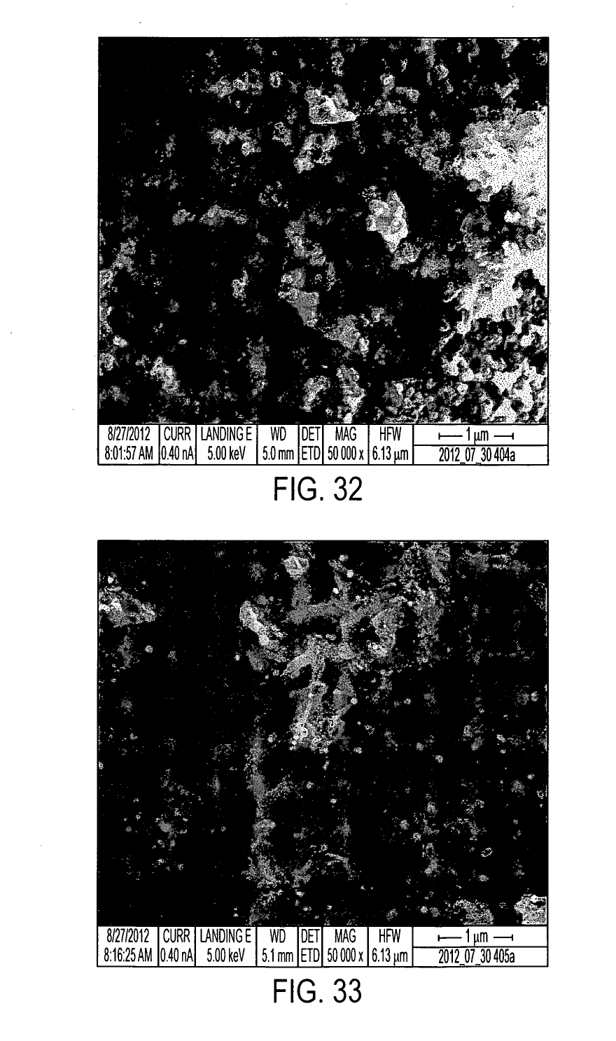

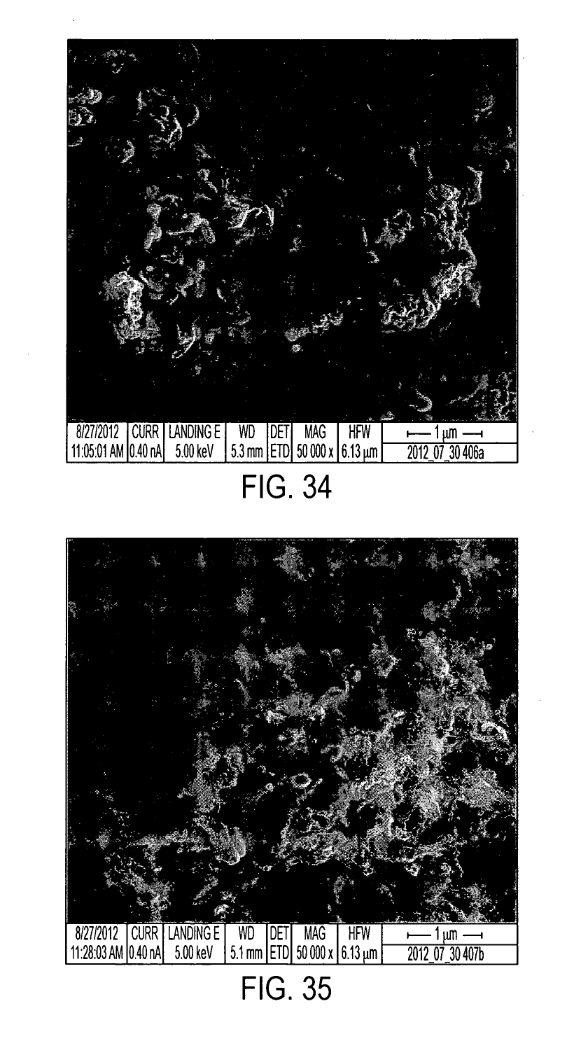

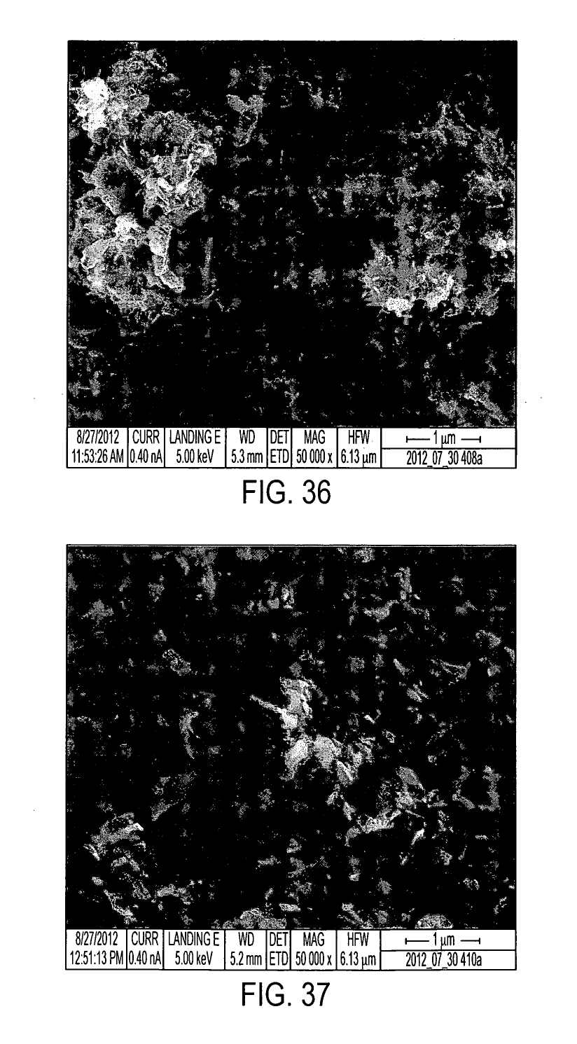

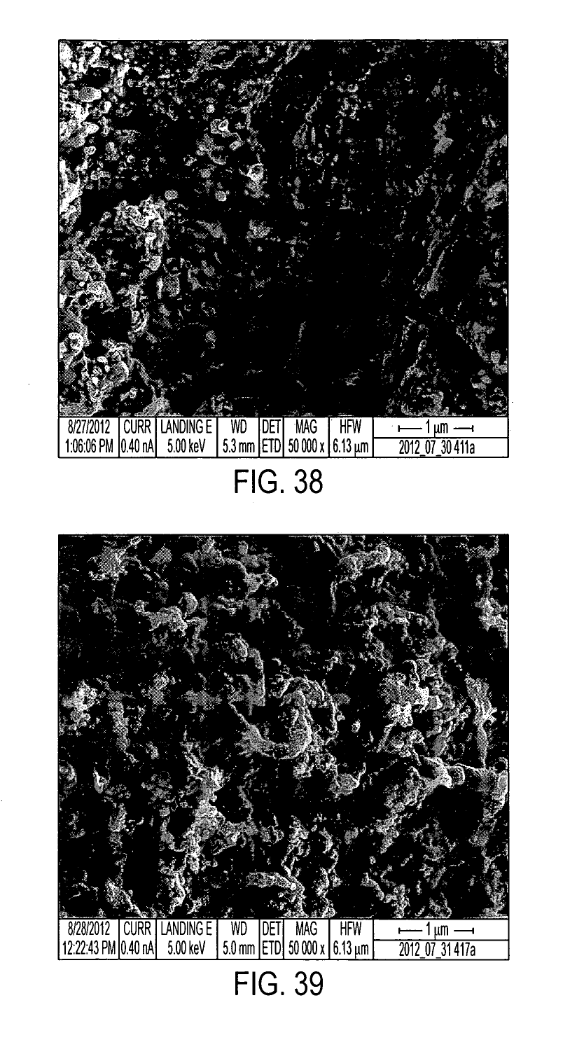

TABLE 3
Solid Carbon Formation from 50% CO and 50% CO₂

| | Sample # | | | | | |
|---|---|---|---|---|---|---|
| | 1 | 2 | 3 | 4 | 5 | 6 |
| Distance from inlet (inches) | 5.5 | 9.1 | 12.4 | 16.1 | 20.1 | 23.4 |
| Temperature (° C.) | 413.9 | 589.1 | 631.2 | 666.7 | 701.1 | 738.2 |
| H₂ composition (%) | | 0.39 | 0.39 | 0.40 | 0.40 | 0.40 |
| CO₂ composition (%) | | 49.7 | 49.7 | 49.6 | 49.6 | 49.5 |
| CO composition (%) | | 49.9 | 49.9 | 50.0 | 50.0 | 50.1 |
| Deposition rate (g/cm²/hr) | 0.000 | 0.011 | 0.011 | 0.007 | 0.014 | 0.009 |
| Surface Area (m²/g) | | 43.9 | 78.5 | | 27.4 | |
| SEM image | | FIG. 31 | FIG. 32 | FIG. 33 | FIG. 34 | FIG. 35 |
| | Sample # | | | | | |
| | 7 | 8 | 9 | 10 | 11 | 12 |
| Distance from inlet (inches) | 26.9 | 30.4 | 33.9 | 37.1 | 40.9 | 44.3 |
| Temperature (° C.) | 785.5 | 844.2 | 897.8 | 891.0 | 825.0 | 523.5 |
| H₂ composition (%) | 0.40 | | 0.41 | | 0.42 | |
| CO₂ composition (%) | 49.5 | | 49.4 | | 49.3 | |
| CO composition (%) | 50.1 | | 50.2 | | 50.3 | |
| Deposition rate (g/cm²/hr) | 0.003 | 0.006 | 0.009 | 0.009 | 0.005 | 0.000 |
| Surface Area (m²/g) | | | | | | |
| SEM image | FIG. 36 | | FIG. 37 | | FIG. 38 | |

### Example 10

Twelve steel coupons were placed in a quartz tube as described above. A reaction gas containing about 90% CO and 10% CO₂ was introduced into the quartz tube at about 4.0 MPa. The gases flowed over the coupons for about two hours at 2000 sccm. Solid carbon formed on ten of the twelve coupons at temperatures between about 590° C. and about 900° C., as shown in Table 4 below. After the test, solid carbon was physically removed from some of the coupons and tested for BET specific surface area, as shown in Table 4. Samples of the solid carbon were imaged using SEM, as shown in FIGS. 39 through 47 at 50,000× magnification. No water was collected from the gases during the test.

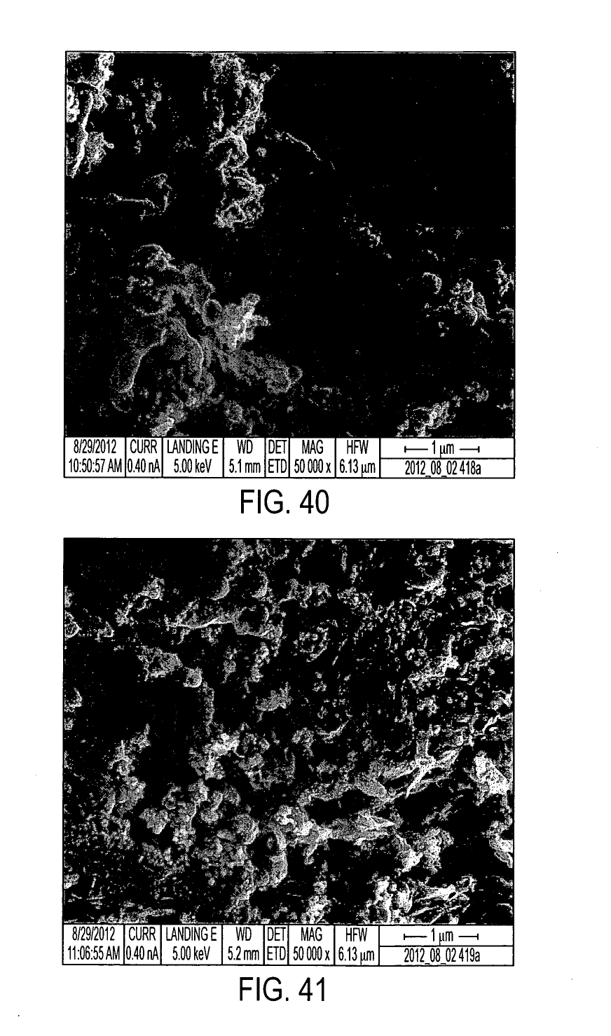

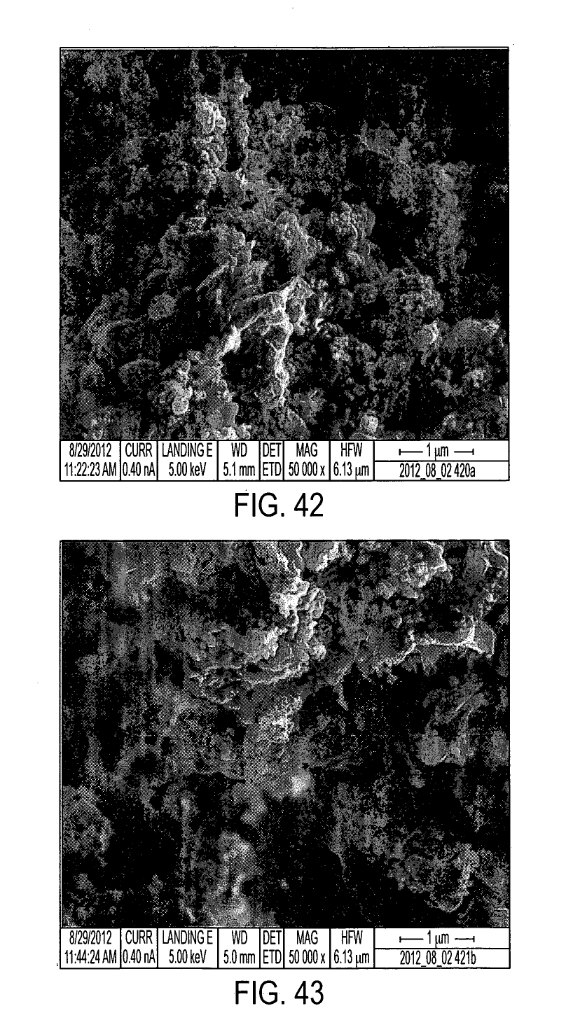

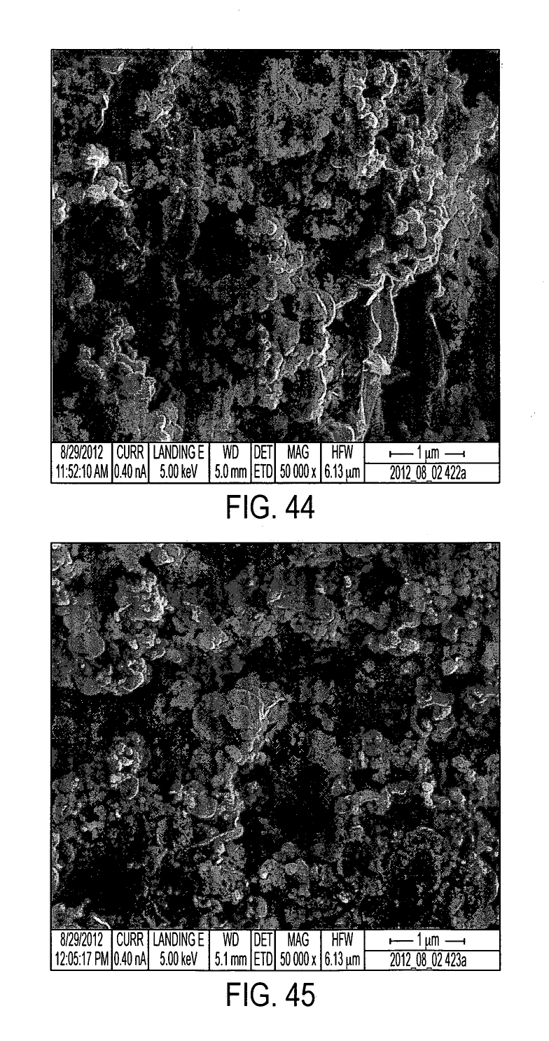

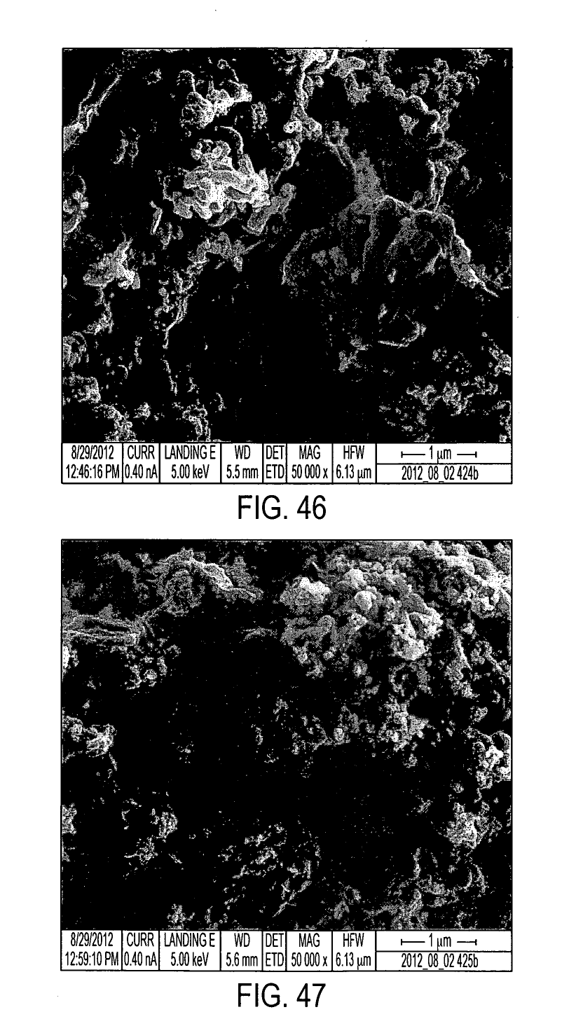

TABLE 4
Solid Carbon Formation from 90% CO and 10% CO₂

| | Sample # | | | | | |
|---|---|---|---|---|---|---|
| | 1 | 2 | 3 | 4 | 5 | 6 |
| Distance from inlet (inches) | 5.4 | 8.9 | 12.4 | 15.9 | 20.6 | 22.9 |
| Temperature (° C.) | 423.6 | 588.5 | 632.6 | 663.1 | 703.2 | 729.4 |
| H₂ composition (%) | | | 0.54 | 0.57 | 0.60 | 0.62 |
| CO₂ composition (%) | | | 11.6 | 12.3 | 13.4 | 13.9 |
| CO composition (%) | | | 87.9 | 87.1 | 86.0 | 85.5 |
| Deposition rate (g/cm²/hr) | 0.000 | 0.001 | 0.083 | 0.118 | 0.064 | 0.066 |
| Surface Area (m²/g) | | | 68.2 | 61.7 | 58.7 | 53.2 |
| SEM image | | | FIG. 39 | FIG. 40 | FIG. 41 | FIG. 42 |
| | Sample # | | | | | |
| | 7 | 8 | 9 | 10 | 11 | 12 |
| Distance from inlet (inches) | 27.1 | 30.9 | 34.8 | 36.4 | 40.6 | 44.4 |
| Temperature (° C.) | 789.4 | 857.1 | 902.4 | 898.7 | 829.0 | 499.3 |
| H₂ composition (%) | 0.65 | 0.68 | 0.71 | 0.72 | 0.42 | |
| CO₂ composition (%) | 14.9 | 15.8 | 16.7 | 18.2 | 49.3 | |
| CO composition (%) | 84.4 | 83.5 | 82.6 | 81.1 | 50.3 | |
| Deposition rate (g/cm²/hr) | 0.030 | 0.019 | 0.005 | 0.005 | 0.027 | 0.000 |
| Surface Area (m²/g) | 44.9 | | | | | |
| SEM image | FIG. 43 | FIG. 44 | FIG. 45 | FIG. 46 | FIG. 47 | |

### Example 11

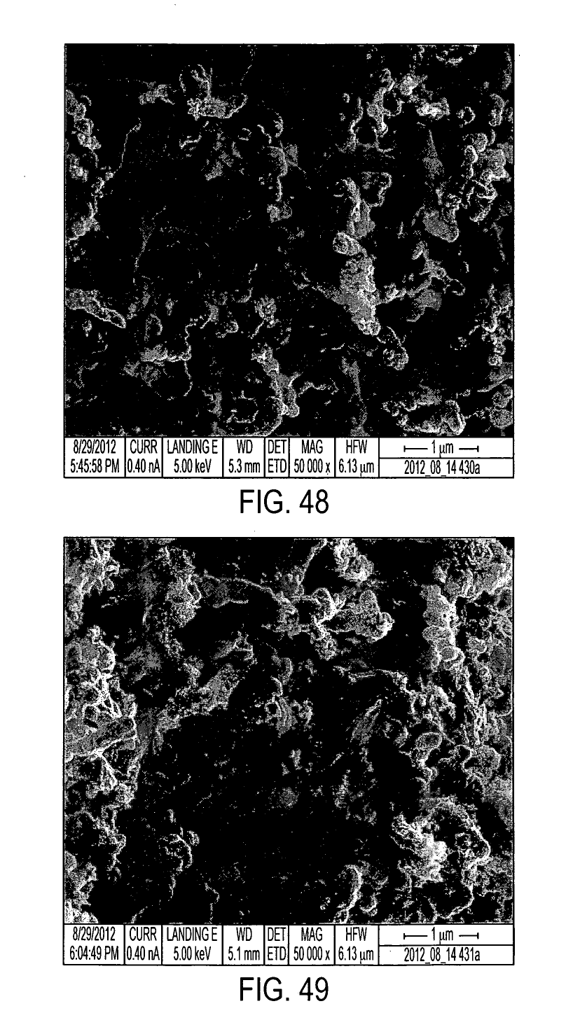

Twelve steel coupons were placed in a quartz tube as described above. A reaction gas containing about 90% CO and 10% CO₂ was introduced into the quartz tube at about 1.5 MPa. The gases flowed over the coupons for about three hours at 2000 sccm. Solid carbon formed on ten of the twelve coupons at temperatures between about 536° C. and about 890° C., as shown in Table 5 below. After the test, solid carbon was physically removed from some of the coupons and tested for BET specific surface area, as shown in Table 5. Samples of the solid carbon were imaged using SEM, as shown in FIGS. 48 through 54 at 50,000× magnification. No water was collected from the gases during the test.

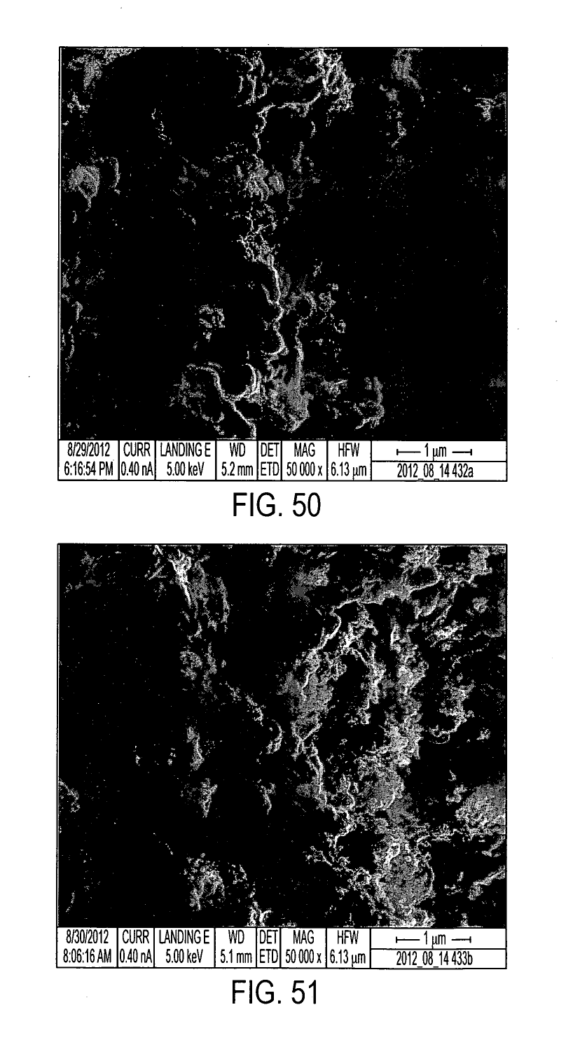

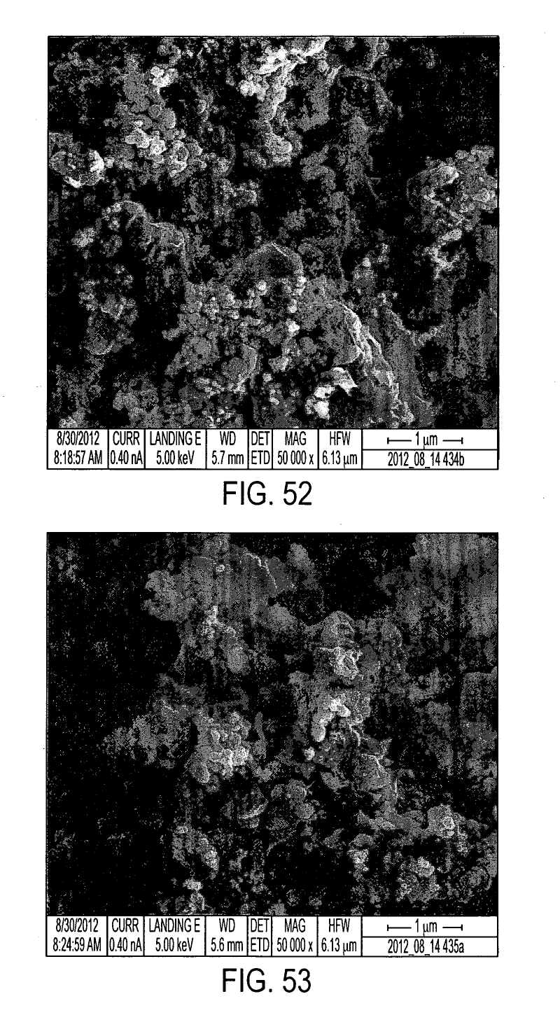

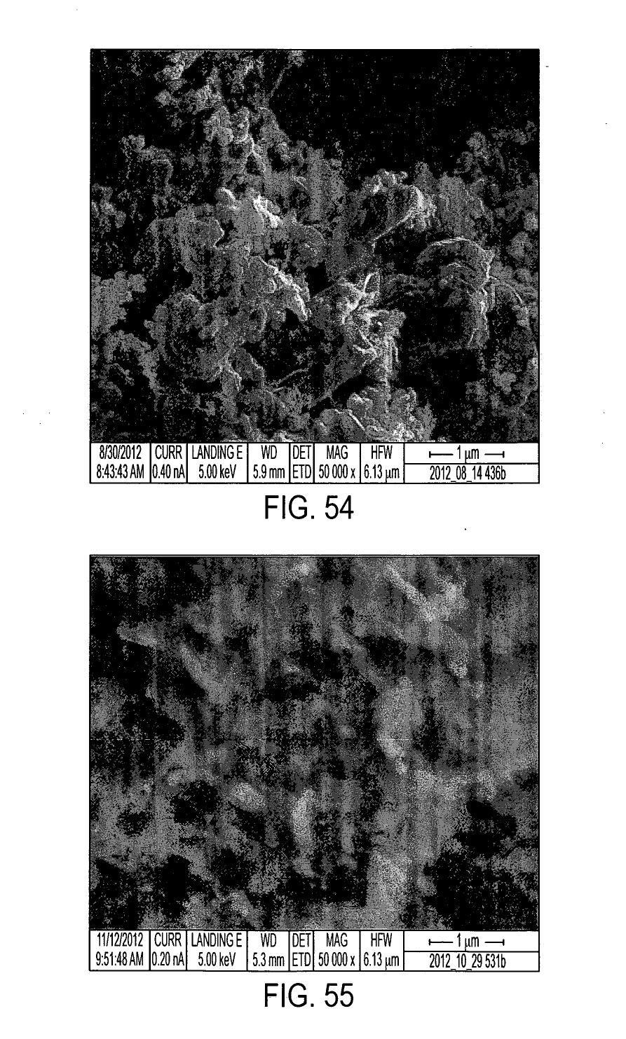

TABLE 5
Solid Carbon Formation from 90% CO and 10% CO₂

| | Sample # | | | | | |
|---|---|---|---|---|---|---|
| | 1 | 2 | 3 | 4 | 5 | 6 |
| Distance from inlet (inches) | 5.3 | 8.9 | 12.6 | 16.0 | 19.6 | 22.6 |
| Temperature (° C.) | 422.8 | 536.4 | 638.8 | 676.3 | 708.2 | 736.0 |
| H₂ composition (%) | | | 0.61 | 0.62 | 0.63 | 0.64 |
| CO₂ composition (%) | | | 9.56 | 9.75 | 9.96 | 10.1 |
| CO composition (%) | | | 89.8 | 89.6 | 89.4 | 89.2 |
| Deposition rate (g/cm²/hr) | 0.000 | 0.001 | 0.011 | 0.013 | 0.013 | 0.020 |
| Surface Area (m²/g) | | | | 53.2 | 50.4 | 44.0 |
| SEM image | | | FIG. 48 | FIG. 49 | FIG. 50 | FIG. 51 |
| | Sample # | | | | | |
| | 7 | 8 | 9 | 10 | 11 | 12 |
| Distance from inlet (inches) | 26.4 | 29.8 | 32.6 | 37.2 | 40.3 | 44.0 |
| Temperature (° C.) | 768.8 | 803.1 | 831.8 | 890.5 | 856.6 | 535.6 |
| H₂ composition (%) | 0.65 | 0.67 | 0.68 | | | |
| CO₂ composition (%) | 10.3 | 10.5 | 10.7 | | | |
| CO composition (%) | 89.0 | 88.8 | 88.6 | | | |
| Deposition rate (g/cm²/hr) | 0.015 | 0.009 | 0.001 | 0.001 | 0.002 | 0.000 |
| Surface Area (m²/g) | 38.7 | 31.5 | | | | |
| SEM image | FIG. 52 | FIG. 53 | FIG. 54 | | | |

### Example 12

Twelve steel coupons were placed in a quartz tube as described above. A reaction gas containing about 13.0% H₂, 15.2% CO, 10.9% CO₂, 57.8% CH₄, and 3.0% Ar was introduced into the quartz tube at about 412 kPa. The gases flowed over the coupons for about six hours at 2000 sccm. Solid carbon formed on seven of the twelve coupons at temperatures between about 464° C. and about 700° C., as shown in Table 6 below. After the test, solid carbon was physically removed from some of the coupons and tested for BET specific surface area, as shown in Table 6. Samples of the solid carbon were imaged using SEM, as shown in FIGS. 55 through 57 at 50,000× magnification. About 7.95 grams of water was collected from the gases during the test.

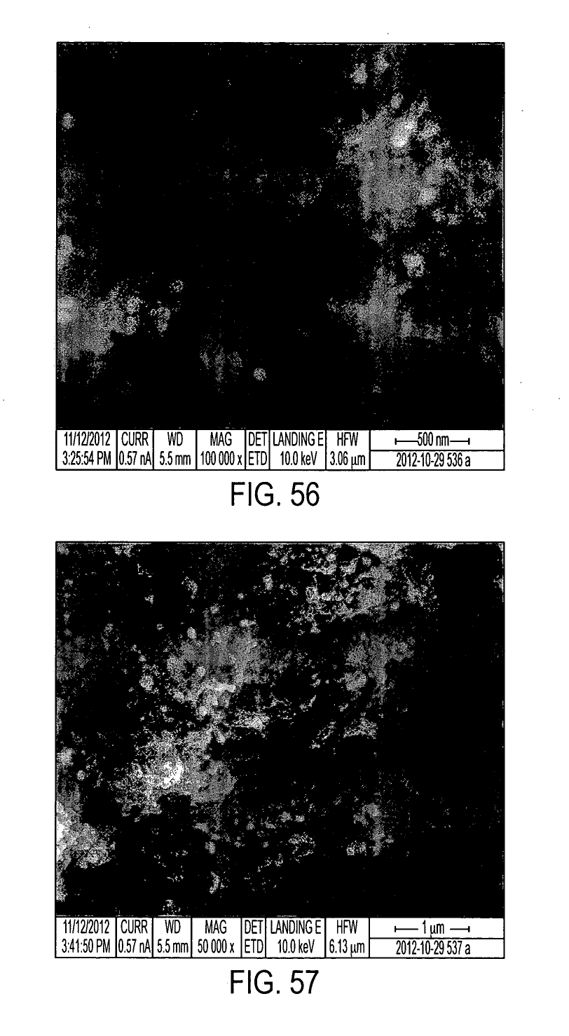

TABLE 6
Solid Carbon Formation from 13.0% H₂, 15.2% CO, 10.9% CO₂, 57.8% CH₄,
and 3.0% Ar

| | Sample # | | | | | |
|---|---|---|---|---|---|---|
| | 1 | 2 | 3 | 4 | 5 | 6 |
| Distance from inlet (inches) | 4.5 | 8.1 | 11.9 | 15.1 | 18.8 | 22.5 |
| Temperature (° C.) | 277.2 | 467.9 | 526.9 | 566.8 | 601.8 | 638.7 |
| H₂ composition (%) | | | 12.3 | | | |
| CH₄ composition (%) | | | 57.8 | | | |
| CO₂ composition (%) | | | 10.9 | | | |
| CO composition (%) | | | 15.1 | | | |
| H₂O composition (%) | | | 0.87 | | | |
| Ar composition (%) | | | 3.16 | | | |
| Deposition rate (g/cm²/hr) | 0.000 | 0.000 | 0.016 | 0.019 | 0.009 | 0.007 |
| Surface Area (m²/g) | | | 189.5 | 245.9 | 228.9 | 142.7 |
| SEM image | | | FIG. 55 | | | |
| | Sample # | | | | | |
| | 7 | 8 | 9 | 10 | 11 | 12 |
| Distance from inlet (inches) | 26.0 | 29.6 | 33.1 | 36.8 | 40.4 | 44.1 |
| Temperature (° C.) | 666.0 | 698.1 | 737.0 | 786.3 | 766.3 | 464.4 |
| H₂ composition (%) | | 11.5 | | | | 10.9 |
| CH₄ composition (%) | | 57.5 | | | | 57.2 |
| CO₂ composition (%) | | 10.1 | | | | 9.39 |
| CO composition (%) | | 14.9 | | | | 14.8 |
| H₂O composition (%) | | 2.85 | | | | 4.49 |
| Ar composition (%) | | 3.18 | | | | 3.20 |
| Deposition rate (g/cm²/hr) | 0.010 | 0.002 | 0.000 | 0.000 | 0.000 | 0.005 |
| Surface Area (m²/g) | 96.7 | 66.7 | | | | 224.8 |
| SEM image | | FIG. 56 | | | | FIG. 57 |

### Example 13

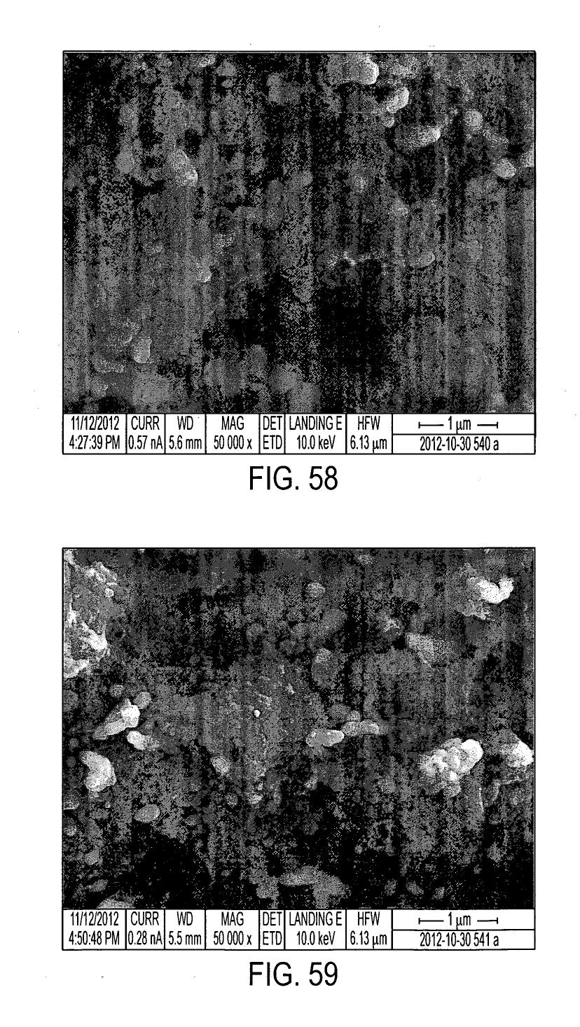

Twelve steel coupons were placed in a quartz tube as described above. A reaction gas containing about 13.0% H₂, 15.2% CO, 13.0% CO₂, 55.8% CH₄, and 2.93% Ar was introduced into the quartz tube at about 412 kPa. The gases flowed over the coupons for about six hours at 2000 sccm. Solid carbon formed on seven of the twelve coupons at temperatures between about 536° C. and about 794° C., as shown in Table 7 below. After the test, solid carbon was physically removed from some of the coupons and tested for BET specific surface area, as shown in Table 7. Samples of the solid carbon were imaged using SEM, as shown in FIGS. 58 through 62 at 50,000× magnification. About 7.38 grams of water was collected from the gases during the test.

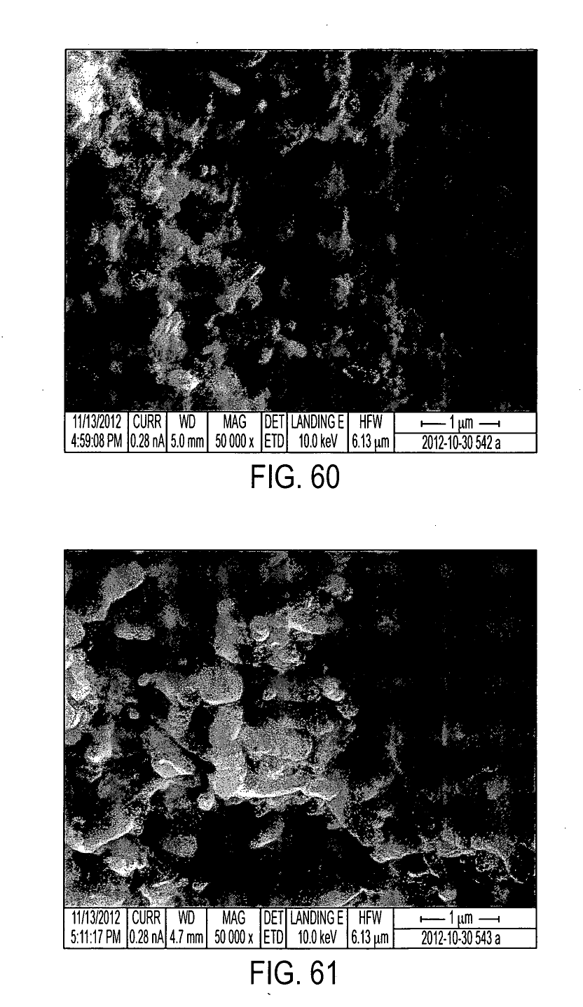

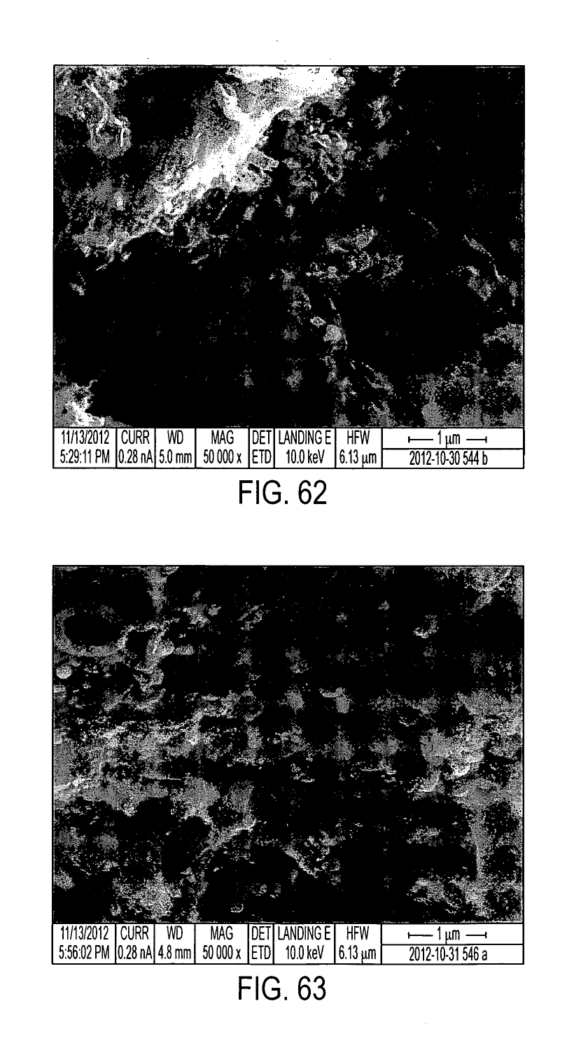

TABLE 7
Solid Carbon Formation from 13.0% H₂, 15.2% CO, 13.0% CO₂, 55.8% CH₄,
and 2.93% Ar

| | Sample # | | | | | |
|---|---|---|---|---|---|---|
| | 1 | 2 | 3 | 4 | 5 | 6 |
| Distance from inlet (inches) | 5.4 | 9.0 | 12.4 | 15.6 | 19.1 | 23.3 |
| Temperature (° C.) | 335.8 | 482.4 | 536.9 | 574.6 | 607.4 | 645.4 |
| H₂ composition (%) | | | | 11.5 | 11.3 | 11.1 |
| CH₄ composition (%) | | | | 55.7 | 55.6 | 55.5 |
| CO₂ composition (%) | | | | 13.3 | 13.1 | 13.0 |
| CO composition (%) | | | | 15.2 | 15.3 | 15.4 |
| H₂O composition (%) | | | | 1.24 | 1.62 | 2.07 |
| Ar composition (%) | | | | 3.04 | 3.06 | 3.07 |
| Deposition rate (g/cm²/hr) | 0.000 | 0.000 | 0.015 | 0.009 | 0.007 | 0.007 |
| Surface Area (m²/g) | | | 225.8 | 251.1 | 189.8 | 132.7 |
| SEM image | | | | FIG. 58 | FIG. 59 | FIG. 60 |
| | Sample # | | | | | |
| | 7 | 8 | 9 | 10 | 11 | 12 |
| Distance from inlet (inches) | 27.0 | 30.4 | 33.8 | 37.5 | 40.8 | 44.5 |
| Temperature (° C.) | 673.4 | 704.6 | 744.3 | 794.1 | 752.9 | 438.7 |
| H₂ composition (%) | 10.8 | 10.6 | | | | |
| CH₄ composition (%) | 55.3 | 55.2 | | | | |
| CO₂ composition (%) | 12.8 | 12.7 | | | | |
| CO composition (%) | 15.5 | 15.6 | | | | |
| H₂O composition (%) | 2.5 | 2.86 | | | | |
| Ar composition (%) | 3.08 | 3.10 | | | | |
| Deposition rate (g/cm²/hr) | 0.004 | 0.0003 | 0.000 | 0.0001 | 0.0001 | 0.0001 |
| Surface Area (m²/g) | 79.4 | | | | | |
| SEM image | FIG. 61 | FIG. 62 | | | | |

### Example 14

Twelve steel coupons were placed in a quartz tube as described above. A reaction gas containing about 15.2% H₂, 13.0% CO, 8.7% CO₂, 59.9% CH₄, and 3.15% Ar was introduced into the quartz tube at about 412 kPa. The gases flowed over the coupons for about six hours at 2000 sccm. Solid carbon formed on ten of the twelve coupons at temperatures between about 523° C. and about 789° C., as shown in Table 8 below. After the test, solid carbon was physically removed from some of the coupons and tested for BET specific surface area, as shown in Table 8. Samples of the solid carbon were imaged using SEM, as shown in FIGS. 63 through 68 at 50,000× magnification. About 9.59 grams of water was collected from the gases during the test.

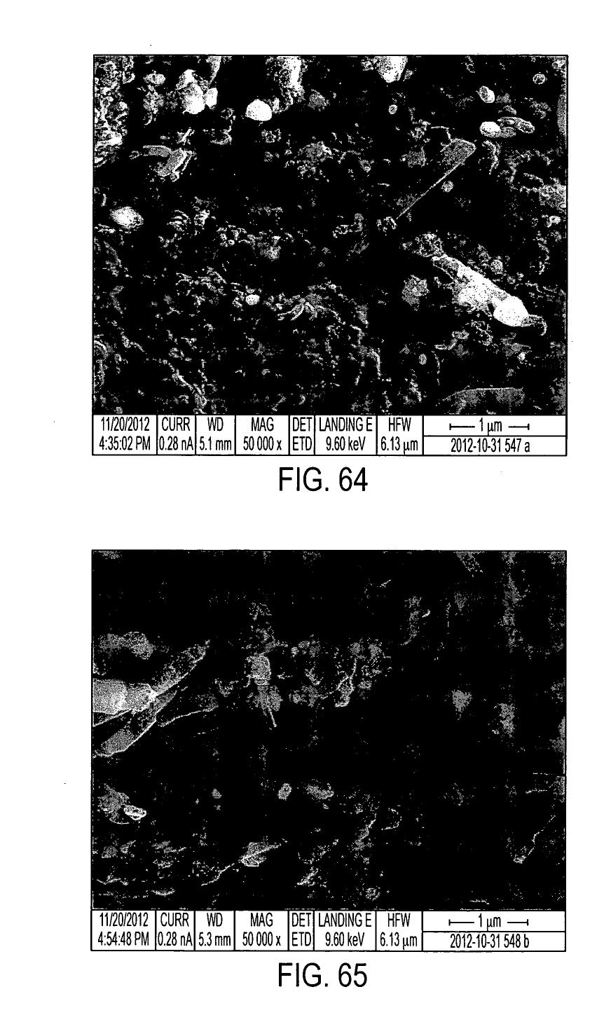

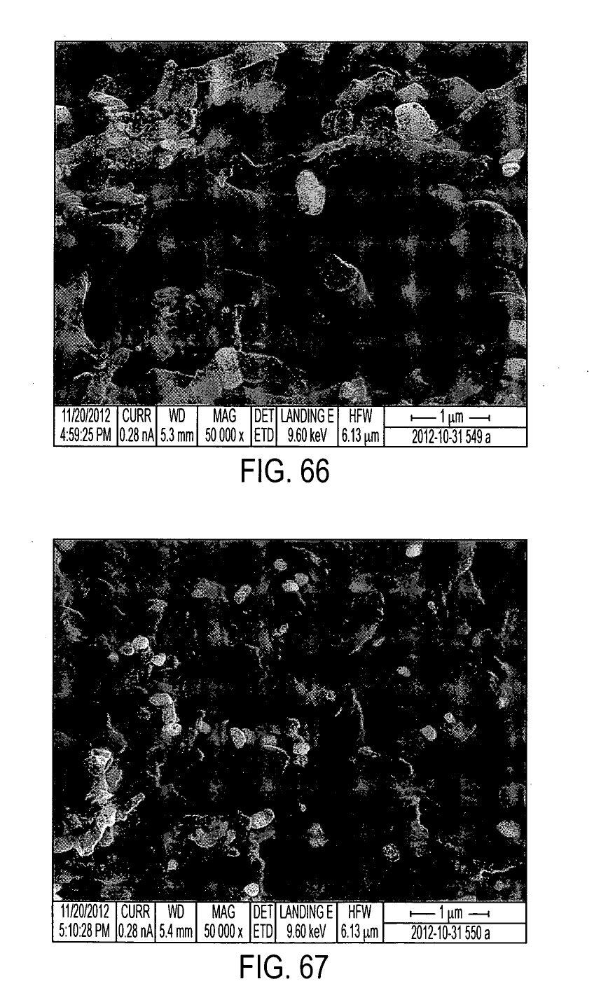

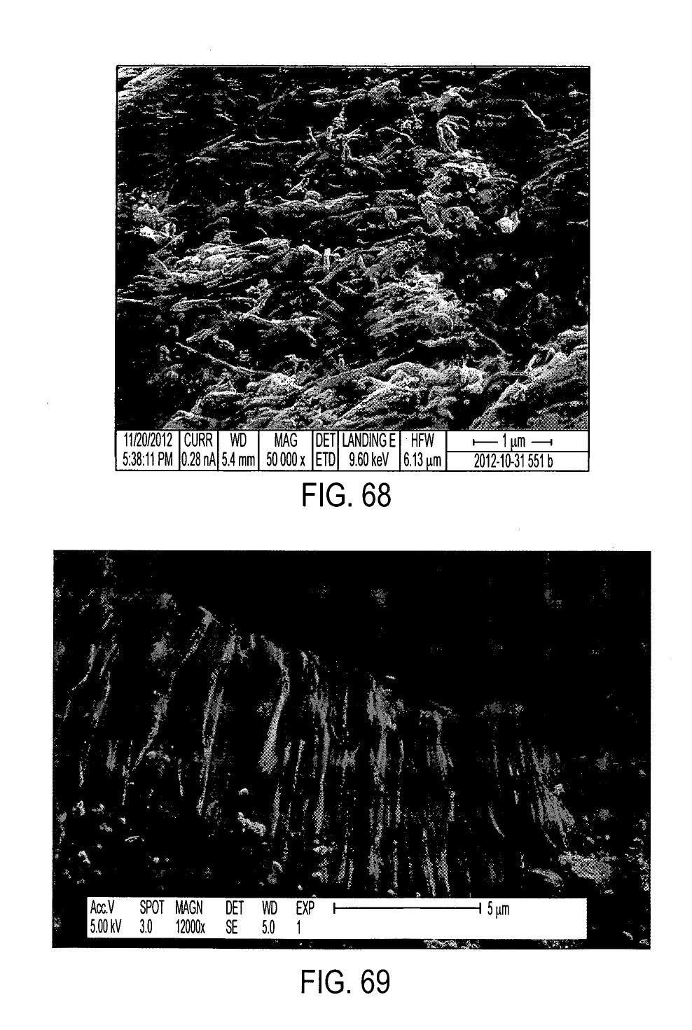

TABLE 8
Solid Carbon Formation from 15.2% H₂, 13.0% CO, 8.7% CO₂, 59.9% CH₄,
and 3.15% Ar

| | Sample # | | | | | |
|---|---|---|---|---|---|---|
| | 1 | 2 | 3 | 4 | 5 | 6 |
| Distance from inlet (inches) | 4.4 | 7.9 | 11.9 | 15.4 | 18.9 | 22.4 |
| Temperature (° C.) | 262.5 | 466.7 | 523.6 | 568.8 | 603.8 | 638.1 |
| H₂ composition (%) | | | | 13.8 | 13.6 | 13.4 |
| CH₄ composition (%) | | | | 59.9 | 59.9 | 59.9 |
| CO₂ composition (%) | | | | 9.36 | 9.21 | 9.07 |
| CO composition (%) | | | | 13.0 | 13.0 | 13.1 |
| H₂O composition (%) | | | | 0.90 | 1.17 | 1.45 |
| Ar composition (%) | | | | 3.15 | 3.15 | 3.16 |
| Deposition rate (g/cm²/hr) | 0.000 | 0.000 | 0.005 | 0.024 | 0.012 | 0.015 |
| Surface Area (m²/g) | | | 149.1 | 233.6 | 209.7 | 128.0 |
| SEM image | | | | FIG. 63 | FIG. 64 | FIG. 65 |
| | Sample # | | | | | |
| | 7 | 8 | 9 | 10 | 11 | 12 |
| Distance from inlet (inches) | 25.8 | 29.4 | 33.3 | 36.5 | 40.1 | 43.6 |
| Temperature (° C.) | 664.0 | 695.1 | 736.5 | 781.3 | 788.8 | 553.2 |
| H₂ composition (%) | 13.2 | 13.1 | 12.9 | | | |
| CH₄ composition (%) | 59.9 | 59.8 | 59.8 | | | |
| CO₂ composition (%) | 8.93 | 8.78 | 8.62 | | | |
| CO composition (%) | 13.1 | 13.2 | 13.2 | | | |
| H₂O composition (%) | 1.72 | 2.01 | 2.32 | | | |
| Ar composition (%) | 3.16 | 3.16 | 3.17 | | | |
| Deposition rate (g/cm²/hr) | 0.013 | 0.001 | 0.0002 | 0.00006 | 0.0001 | 0.008 |
| Surface Area (m²/g) | 76.9 | 77.3 | | | | 251.5 |
| SEM image | FIG. 66 | FIG. 67 | FIG. 68 | | | |

### Example 15

A steel coupon was placed in a quartz tube as described above. A reaction gas containing about 13% H₂, 15% CO, 15% CO₂, 54% CH₄, and 3% Ar was introduced into the quartz tube at about 400 kPa. The gases flowed over the coupon for about 6 hours at 2000 sccm, and the coupon was maintained at about 600° C. A sample of the solid carbon was imaged using SEM, as shown in FIG. 69 at 12,000× magnification.

### Example 16

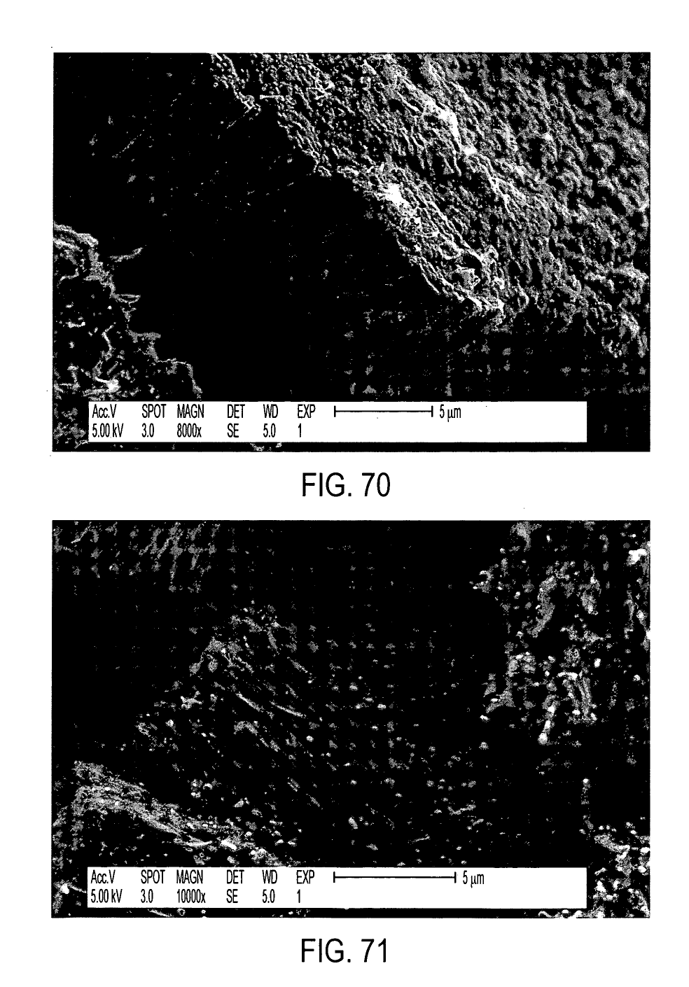

A steel coupon was placed in a quartz tube as described above. A reaction gas containing about 12% H₂, 14% CO, 56% CO₂, 9.5% CH₄, 0.5% Ar, and 8% H₂O was introduced into the quartz tube at about 400 kPa. The gases flowed over the coupon for about 6 hours at 2000 sccm, and the coupon was maintained at about 680° C. A sample of the solid carbon was imaged using SEM, as shown in FIG. 70 at 8,000× magnification.

### Example 17

A steel coupon was placed in a quartz tube as described above. A reaction gas containing about 13% H₂, 17% CO, 15.5% CO₂, 52% CH₄, and 2.5% Ar was introduced into the quartz tube at about 400 kPa. The gases flowed over the coupon for about 6 hours at 2000 sccm, and the coupon was maintained at about 660° C. A sample of the solid carbon was imaged using SEM, as shown in FIG. 71 at 10,000× magnification.

### Example 18

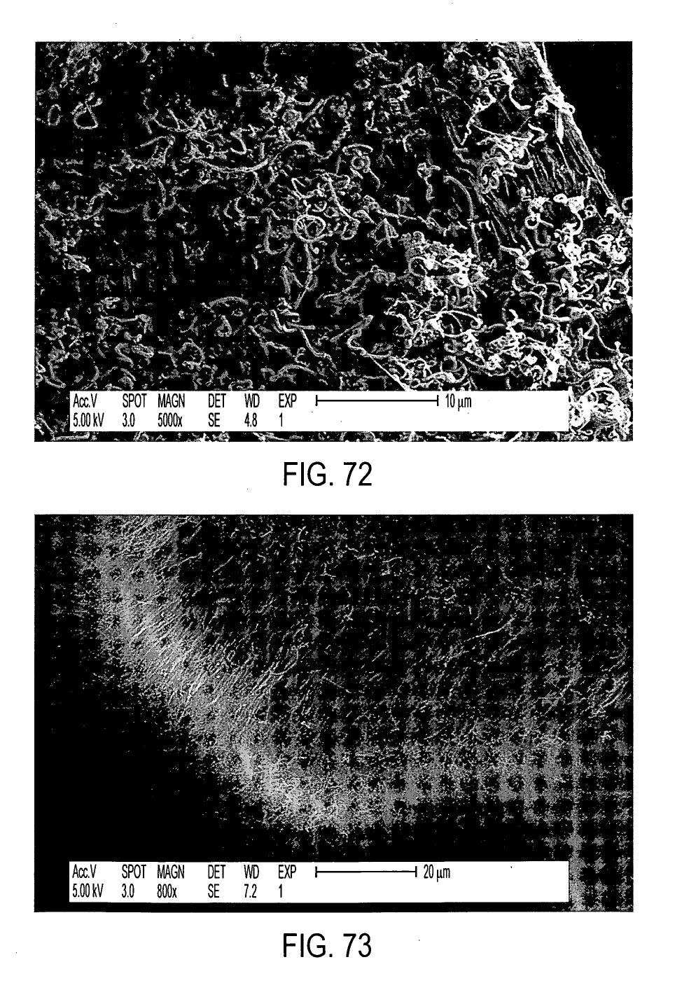

A steel coupon was placed in a quartz tube as described above. A reaction gas containing about 13% H₂, 17% CO, 15.5% CO₂, 52% CH₄, and 2.5% Ar was introduced into the quartz tube at about 170 kPa. The gases flowed over the coupon for about 4 hours at 2000 sccm, and the coupon was maintained at about 630° C. A sample of the solid carbon was imaged using SEM, as shown in FIG. 72 at 5,000× magnification.

### Example 19

A steel coupon was placed in a quartz tube as described above. A reaction gas containing about 15.22% H₂, 13.04% CO, 8.7% CO₂, 59.89% CH₄, and 23.15% Ar was introduced into the quartz tube at about 400 kPa. The gases flowed over the coupon for about 4 hours at 2000 sccm, and the coupon was maintained at about 600° C. A sample of the solid carbon was imaged using SEM, as shown in FIG. 73 at 800× magnification and in FIG. 74 at 10,000× magnification.

### Example 20

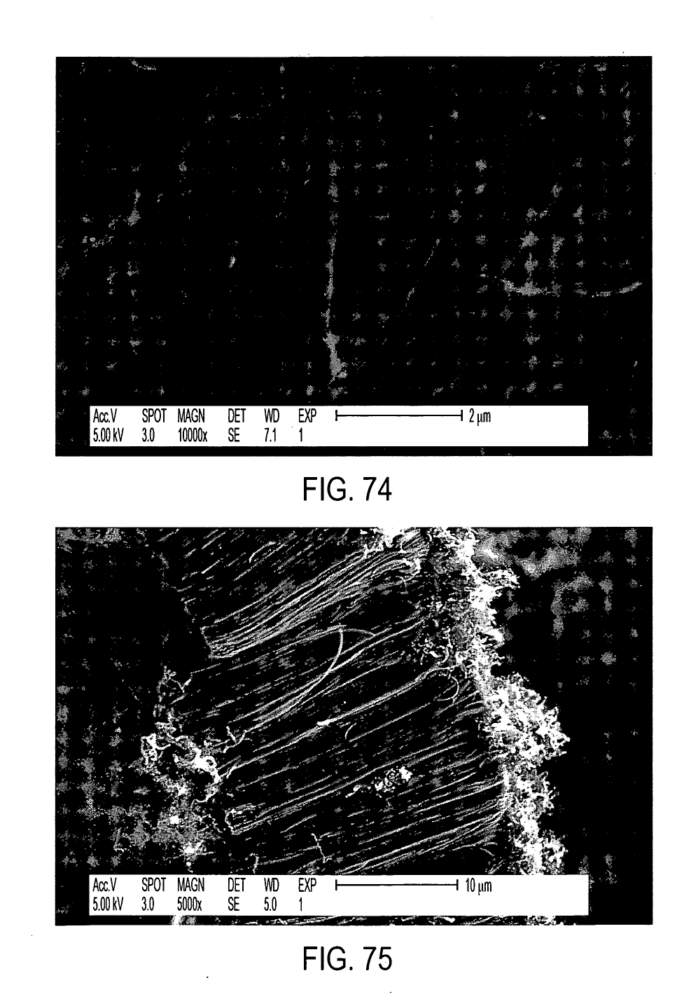

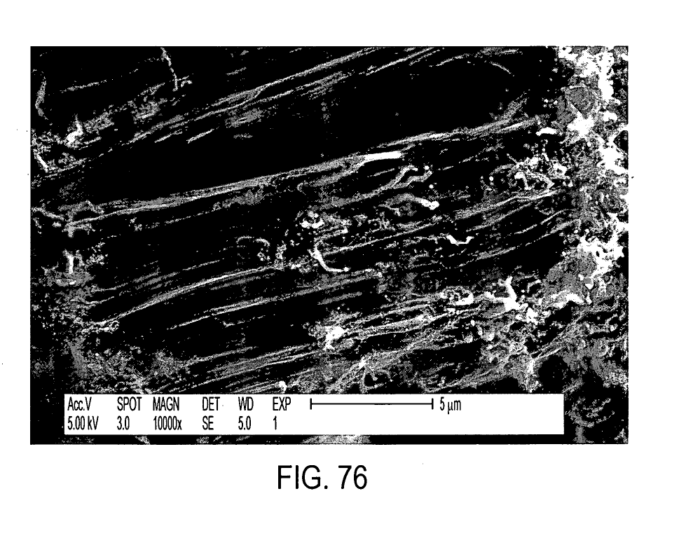

A steel coupon was placed in a quartz tube as described above. A reaction gas containing about 48% H₂, 13% CO, 21% CO₂, and 18% CH₄ was introduced into the quartz tube at about 170 kPa. The gases flowed over the coupon for about 2 hours at 2000 sccm, and the coupon was maintained at about 625° C. A sample of the solid carbon was imaged using SEM, as shown in FIG. 75 at 5,000× magnification and in FIG. 76 at 10,000× magnification.

For Examples 21 through 23, a laboratory setup was used as described above for Examples 1 through 7 and illustrated in FIG. 4.

TABLE 9
Conditions for Examples 21 and 22

| | Carbon | Reducing | | | | |
|---|---|---|---|---|---|---|
| Example | Oxide | Agent | Catalyst | Conditions | | |
| Example 21: | CO₂ | Hydrogen | mild | Pressure | = | 113.3 kPa |
| Bi-modal CNT | | | steel | Temp | = | 700° C. |
| Forest Growth | | | pipe | Time | = | 4 hour |
| Example 22: | CO₂ | Hydrogen | Stainless | Pressure | = | 110.7 kPa |
| Bi-modal CNT | | | steel | | | to 116 kPa |
| Forest Growth | | | pipe | Temp | = | 600° C. |
| | | | | Time | = | 1 hour |

### Example 21

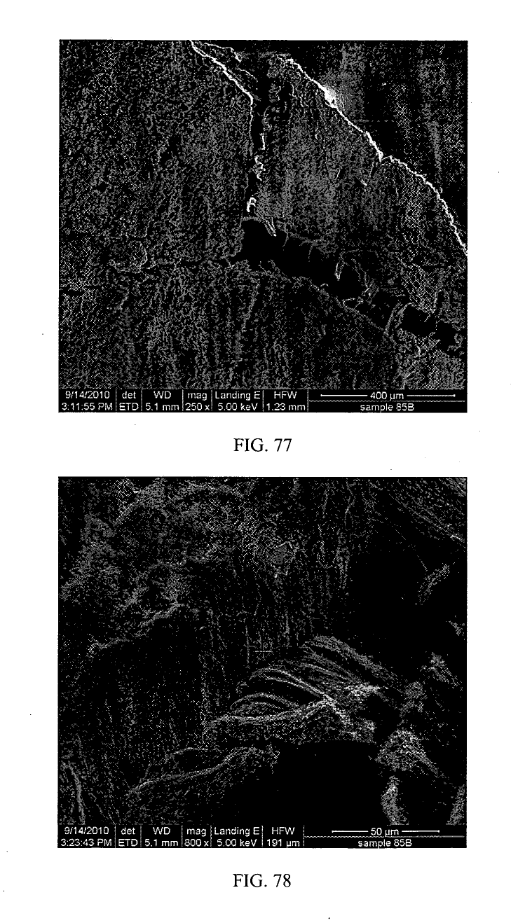

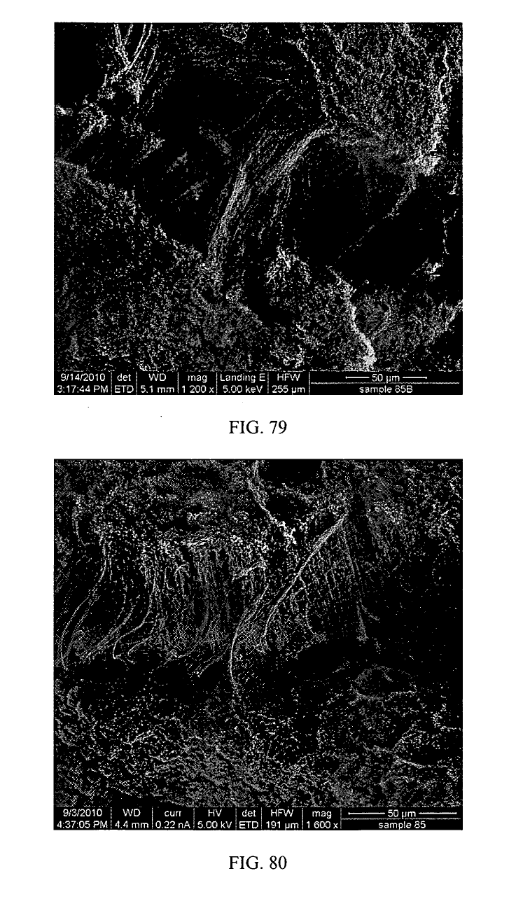

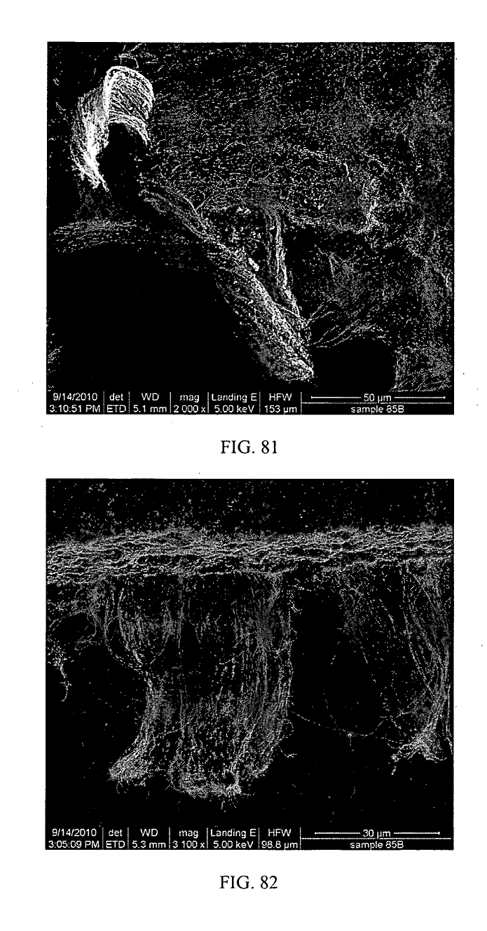

A mild steel tube having a length of about 120 cm and an inner diameter of about 5 cm was placed in the furnace 1 at approximately the centerline. Reaction gas flow was directed from the top of the reactor downward, which aided in the collection of the solid carbon product. The reactor pipe was removed from the furnace 1 after the furnace had cooled. The solid carbon product was scraped form the reactor walls and a sample was tested by SEM. FIGS. 77 through 82 show SEM images at progressively greater magnification: 250×, 800×, 1200×, 1600×, 2000×, and 3100×. At these magnifications, the forest growth morphology of the material can be observed.

### Example 22

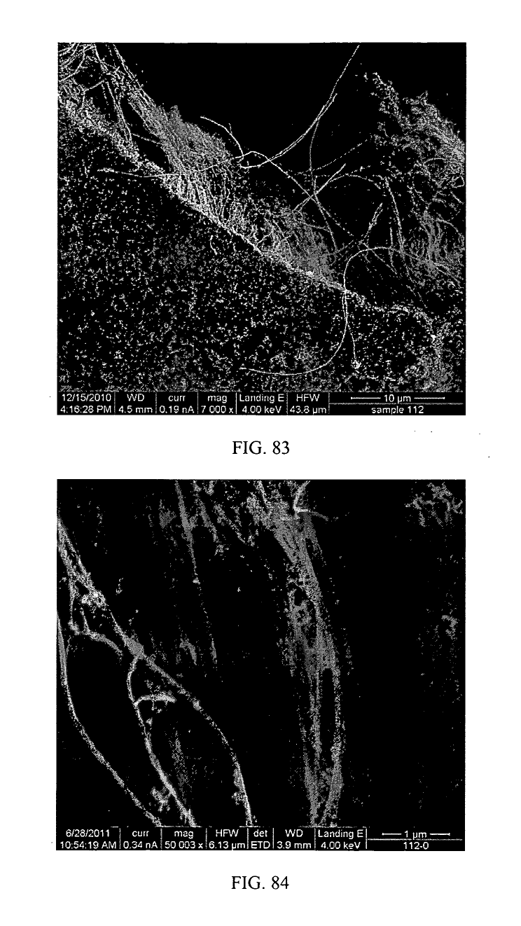

A stainless steel tube having a length of about 120 cm and an inner diameter of about 5 cm was placed in the furnace 1 at approximately the centerline. Reaction gas flow was directed from the top of the reactor downward, which aided in the collection of the solid carbon product. The reactor pipe was removed from the furnace 1 after the furnace had cooled. The solid carbon product was scraped form the reactor walls and a sample was tested by SEM. FIGS. 83 and 84 show SEM images at magnifications at 7,000×, and 50,000×, respectively. At these magnifications, the forest growth morphology of the material can be observed.

Various commercially available catalysts may be substituted in the previous examples to form solid carbon products of a similar nature as the examples. Thus, the catalyst may be comprised of INCONEL®, a HASTELLOY®, mild steel, various grades of stainless steel, etc. The size and morphology of the solid carbon nanotube product may be controlled by controlling the grain size of the metal catalyst.

Although the foregoing description contains specific details, these are not to be construed as limiting the scope of the present invention, but merely as providing certain embodiments. Similarly, other embodiments of the invention may be devised that do not depart from the scope of the present invention. For example, features described herein with reference to one embodiment also may be provided in others of the embodiments described herein. The scope of the invention is, therefore, indicated and limited only by the appended claims and their legal equivalents, rather than by the foregoing description. All additions, deletions, and modifications to the invention, as disclosed herein, which fall within the meaning and scope of the claims, are encompassed by the present invention.

1-3. (canceled)

4. The method of claim 19, wherein exposing the catalyst surface to the reaction gas mixture for a predetermined exposure time to produce the solid carbon forests on the catalyst surface comprises reacting carbon dioxide with gases of the reducing atmosphere.

5. (canceled)

6. The method of claim 19, further comprising treating the catalyst surface by at least one of ion bombardment, etching, oxidizing, reducing, annealing, quenching, and recrystallizing.

7-9. (canceled)

10. The method of claim 19, further comprising chemically modifying the catalyst surface by contacting the solid carbon forests with a solvent comprising at least one of water, an alcohol, or an acid.

11-12. (canceled)

13. A reactor for producing solid carbon forests, comprising:
a metal catalyst;
means for facilitating the reduction of a carbon oxide comprising a plurality of reactor sections configured to operate independently to form solid carbon forests on a surface of the metal catalyst; and
means for removing the solid carbon forests from the surface of the metal catalyst.

14. The reactor of claim 13, wherein the means for facilitating the reduction of a carbon oxide further comprises a conveyor configured to continuously transport the metal catalyst through a reaction zone to the means for removing the solid carbon forests from the surface of the metal catalyst.

15. The reactor of claim 14, wherein a first portion of the conveyor is disposed within the means for facilitating the reduction of a carbon oxide and a second portion of the conveyor is disposed within the means for removing the solid carbon forests from the surface of the metal catalyst.

16. (canceled)

17. The reactor of claim 13, wherein the means for removing the solid carbon forests from the surface of the metal catalyst comprises a means for at least one of agitating the metal catalyst, shaking the metal catalyst, vibrating the metal catalyst, scraping the metal catalyst surface, abrading the metal catalyst surface, and contacting the metal catalyst with a solvent.

18. The reactor of claim 13, wherein the metal catalyst is configured to define a tortuous path through the reactor.

19. A method of producing solid carbon forests, comprising:
placing a catalyst surface in a reaction chamber;
heating the catalyst surface in a reducing atmosphere for a predetermined conditioning time to a predetermined reaction temperature and a predetermined reaction pressure;
introducing a carbon-oxide-bearing gaseous reactant into the reducing atmosphere of the reaction chamber to form a reaction gas mixture;
exposing the catalyst surface to the reaction gas mixture for a predetermined exposure time to produce the solid carbon forests on the catalyst surface;
maintaining a concentration of the reaction gases in the reaction gas mixture during the predetermined exposure time;
controlling a concentration of water vapor in the reaction gas mixture to predetermined levels during the predetermined exposure time;
introducing a first gas mixture into the reaction chamber to functionalize the solid carbon forests;
removing the first gas mixture from the reaction chamber; and
introducing a second gas mixture into the reaction chamber to cool action chamber.

20. The method of claim 19, wherein heating the catalyst surface in a reducing atmosphere comprises reducing the catalyst surface for a time sufficient to sufficiently reduce any oxides on the catalyst surface.

21-44. (canceled)

45. A method of producing carbon nanotubes, comprising:
conditioning a catalyst to form a surface structure of a selected chemical composition;
disposing the catalyst in a reactor;
purging the reactor of oxygen;
introducing a reducing agent to the reactor;
heating the catalyst in the presence of the reducing agent to reduce metal oxides on a surface of the catalyst and provide a substantially oxygen-free surface having the selected chemical composition;
reacting a gaseous carbon oxide in the presence of the catalyst and the reducing agent;
controlling at least one of a reactor temperature, a reactor pressure, a reaction gas composition, and an exposure time of the catalyst to the gaseous carbon oxide and the reducing agent to produce water and carbon nanotubes of a selected morphology; and
chemically modifying the surface of the catalyst by contacting the carbon nanotubes with solvent comprising at least one of water, an alcohol, and an acid.

46-75. (canceled)

76. The method of claim 45, wherein reacting a gaseous carbon oxide in the presence of the catalyst and the reducing agent comprises reacting carbon dioxide with a gaseous reducing agent.

77. The method of claim 45, further comprising:
transporting the catalyst through a reaction zone, wherein at least a portion of the gaseous carbon oxide and the reducing agent are disposed within the reaction zone; and
transporting the catalyst through a means for removing carbon from the surface of the catalyst.

78-86. (canceled)

87. The method of claim 45, further comprising:
introducing a first gas mixture into the reactor to functionalize the carbon nanotubes;
removing the first gas mixture from the reactor; and
introducing a second gas mixture into the reactor to cool the reactor.

88. The method of claim 45, wherein conditioning a catalyst comprises introducing a steel catalyst having a preselected chemical and surface structure into the reactor.

89. The method of claim 45, wherein disposing the catalyst in a reactor comprises disposing at least two catalyst surface structures of different chemical compositions into the reactor.

90. The method of claim 45, wherein disposing the catalyst in a reactor comprises mounting at least one solid catalyst surface to a surface of the reactor.

91. The method of claim 45, wherein purging the reactor of oxygen comprises displacing substantially all air from the reactor.

92. The method of claim 45, wherein heating the catalyst in the presence of the reducing agent comprises controlling a temperature of the catalyst by controlling at least one of a flow rate of the reducing agent and a temperature of the reducing agent.

93. (canceled)

94. The method of claim 45, further comprising oxidizing the surface of the catalyst for a predetermined time prior to heating the catalyst in the presence of the reducing agent.

95. (canceled)
